(19) United States
(12) Patent Application Publication
(10) Pub. No.: US 2026/0080402 A1
(43) Pub. Date: Mar. 19, 2026

(54) METHOD FOR AUTHENTICATING TRANSACTIONS IN REAL-TIME

(71) Applicant: Elfstone Inc., Vancouver (CA)

(72) Inventors: Vikram Devdas, Vancouver (CA); Sidhant Bahl, Vancouver (CA)

(21) Appl. No.: 19/334,031

(22) Filed: Sep. 19, 2025

Related U.S. Application Data
(63) Continuation of application No. 18/228,541, filed on Jul. 31, 2023, now abandoned.
Application No. 18/228,541 is a continuation-in-part of application No. 17/184,038, filed on Feb. 24, 2021, now abandoned.
(60) Provisional application No. 62/980,957, filed on Feb. 24, 2020.
(60) Provisional application No. 63/105,751, filed on Oct. 26, 2020.

(51) Int. Cl. G06Q 20/40; B60L 53/62; B60L 53/66; G06Q 20/42; G06Q 50/06

(52) U.S. Cl. CPC G06Q 20/40; B60L 53/62; B60L 53/665; G06Q 20/42; G06Q 50/06

(57) ABSTRACT

One variation of a method for detecting fraudulent transactions includes, in response to receiving a first transaction request for a first transaction initiated at a first merchant, the first transaction request specifying a payment identifier and a first transaction value, accessing a user profile associated with a user based on the payment identifier. The method further includes, in response to the first transaction value exceeding a threshold transaction value stored at the user profile: transmitting a verification request to the user to confirm the first transaction; and, in response to receiving confirmation of the first transaction from the user, approving the first transaction request. The method further includes, in response to receiving a second transaction request for a second transaction initiated at a second merchant, the second transaction request specifying the payment identifier and a second transaction value less than the threshold transaction value, approving the second transaction request.

### CROSS-REFERENCE TO RELATED APPLICATIONS

This application is a Continuation of U.S. patent application Ser. No. 18/228,541, filed on 31 Jul. 2023, which is a Continuation-In-Part of U.S. patent application Ser. No. 17/184,038, filed on 24 Feb. 2021, which claims the benefit of U.S. Provisional Application No. 63/105,751, filed on 26 Oct. 2020, and U.S. Provisional Application No. 62/980,957, filed on 24 Feb. 2020, each of which is incorporated in its entirety by this reference.

### TECHNICAL FIELD

This invention relates generally to the field of transaction security and more specifically to a new and useful method for detecting fraudulent transactions in the field of transaction security.

### BRIEF DESCRIPTION OF THE FIGURES

FIG. 1 is a flowchart representation of a method;

FIG. 2 is a flowchart representation of the method;

FIG. 3 is a flowchart representation of the method;

FIG. 4 is a flowchart representation of the method; and

FIGS. 5A and 5B are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

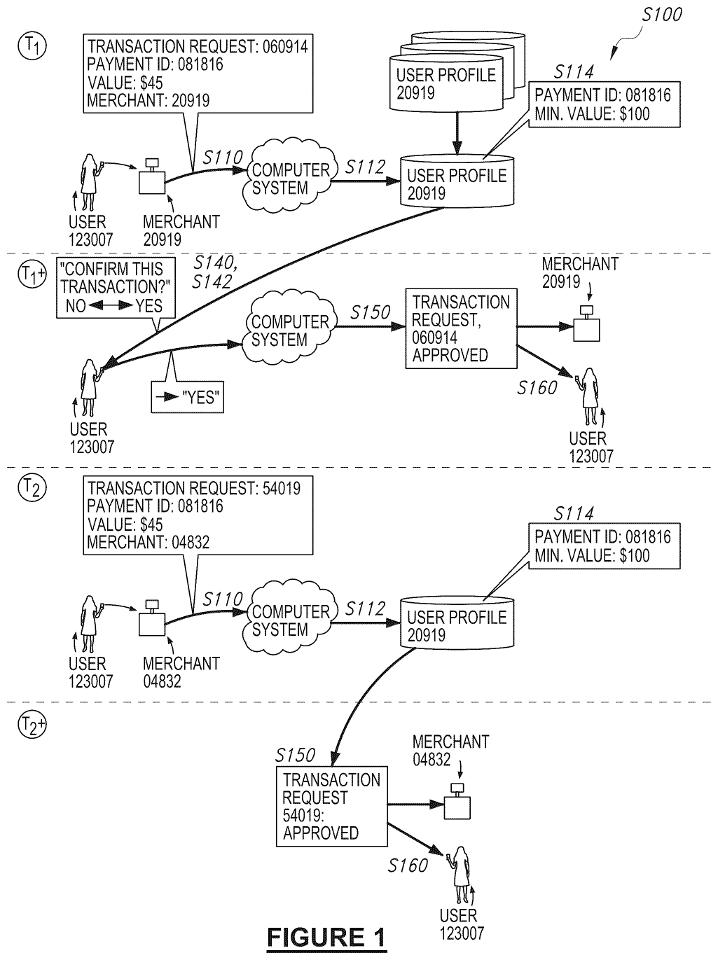

As shown in FIGS. 1-4, a method S100 for verifying transaction authenticity includes, during a first period, in response to receiving a first transaction request (e.g., by a transaction request receiving module) for a first transaction (e.g., financial, transfer or delivery of goods) initiated at a first merchant (e.g., in-store or online merchant) in Block S110, the first transaction request specifying a first transaction value and a first payment identifier: accessing a first user profile, in a set of first user profiles, associated with a user based on the first payment identifier (e.g., by a profile identification module) in Block S112; and extracting a threshold transaction value, specified by the user, from the first user profile (e.g., by a settings extraction module) in Block S114. The method S100 further includes, during the first period, in response to the first transaction value exceeding the first threshold transaction value: generating a first verification request comprising a prompt for the user to confirm the first transaction (e.g., by a verification request generation module) in Block S140; transmitting the first verification request to a computing device associated with the user (e.g., by a user communication module) in Block S141; and, in response to receiving confirmation of the first transaction from the user at the first computing device, approving the first transaction request (e.g., by a transaction approval module) in Block S150.

In this variation, the method S100 further includes, during a second period, in response to receiving a second transaction request (e.g., by the transaction request receiving module) for a second transaction initiated at a second merchant in Block S110, the second transaction request specifying a second transaction value and the first payment identifier: accessing the first user profile associated with the user based on the first payment identifier (e.g., by the profile identification module) in Block S112; extracting the threshold transaction value, specified by the user, from the first user profile (e.g., by the settings extraction module) in Block S114; and, in response to the second transaction value falling below the threshold transaction value, approving the second transaction request (e.g., by the transaction approval module) in Block S150.

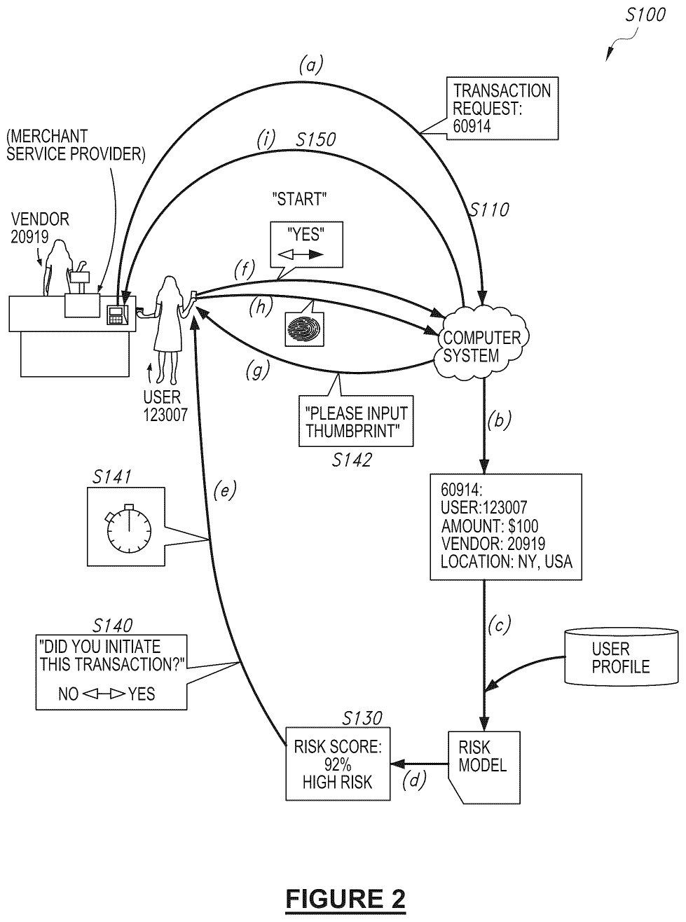

As shown in FIG. 2-4, one variation of the method S100 further includes, during the first period, in response to the first transaction value exceeding a second threshold transaction value greater than the first threshold transaction value: generating a second prompt for the user to input a first identifier at the first computing device to confirm an identity of the user (e.g., by an identification request generation module) in Block S142; and transmitting the second prompt to the user at the first computing device (e.g., by the user communication module) in Block S143. In this variation, the method S100 further includes, in response to receiving the first identifier from the user: comparing the first identifier to a target identifier stored in the first user profile (e.g., by an identification confirmation module) in Block S146; and in response to the first identifier corresponding to the target identifier, confirming verification of the identity of the user (e.g., by a verification confirmation module) and approving the first transaction request (e.g., by the transaction approval module) in Block S150.

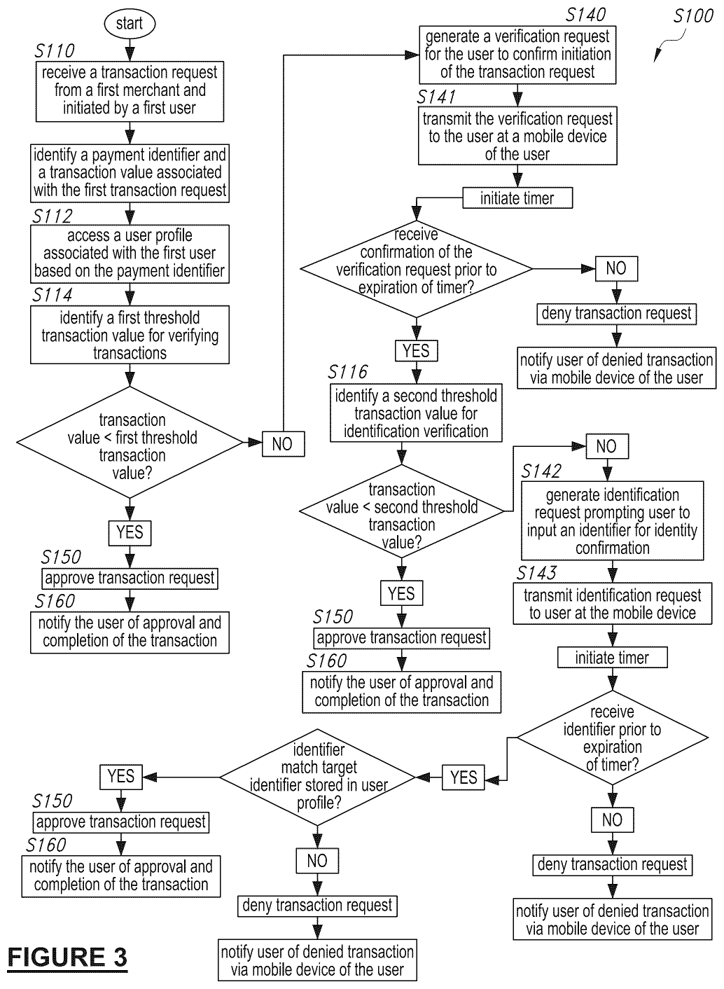

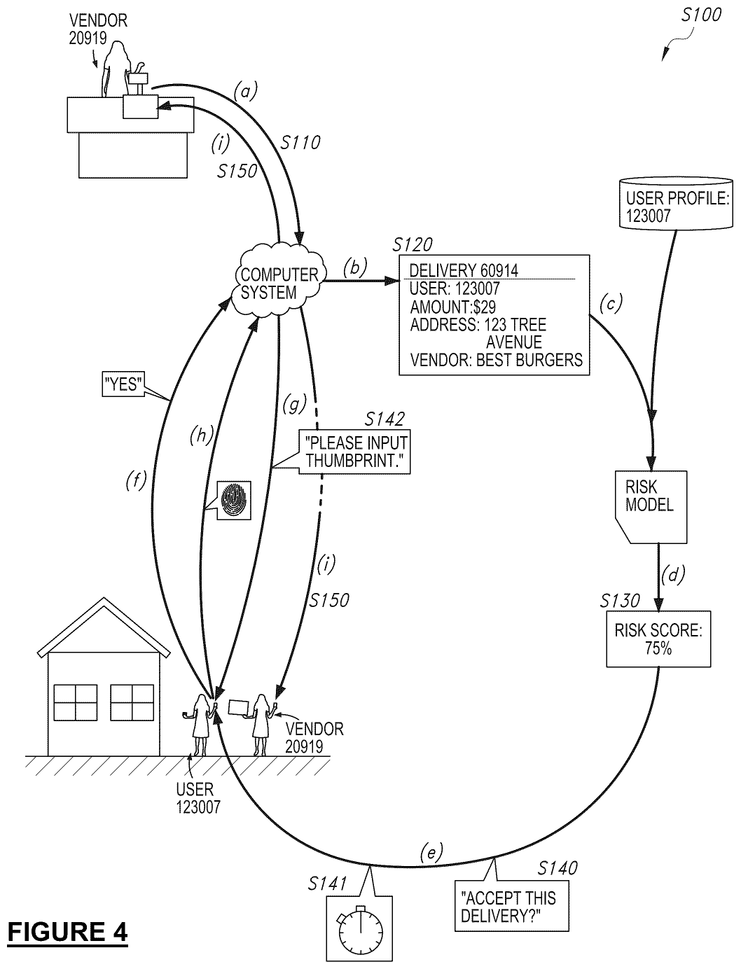

As shown in FIGS. 3 and 4, one variation of a method S100 for detecting fraudulent transactions includes: receiving a first transaction request corresponding to a first transaction initiated by a first user in Block S110; extracting a first set of transaction characteristics for the first transaction including an identity of the first user, an amount of the first transaction, a merchant at which the first transaction was initiated, and a geographic location at which the first transaction occurred in Block S120; and estimating a risk score for the first transaction based on the first set of transaction characteristics in Block S130. The method S100 further includes, in response to the risk score exceeding a first risk threshold: transmitting a verification request to a mobile device of the first user, the verification request a prompt for the first user to verify the first transaction in Block S140; initiating a timer for receiving confirmation of the first transaction responsive to the verification request in Block S141; in response to receiving confirmation of the first transaction from the first user, prompting the first user to input an identifier (e.g., a biometric, passcode, response to a question unique to the first user) to confirm the identity of the first user in Block S142; and, in response to receiving the first identifier before expiration of the timer and the identifier matching a stored identifier for the first user, approving the first transaction request in Block S150.

As shown in FIG. 4, one variation of the method S100 includes, during a first period: receiving a first delivery request for a first delivery from a first merchant in Block S110, the first delivery request specifying a set of delivery characteristics comprising a first delivery type and a first user; accessing a risk model configured to characterize risk of deliveries based on the set of delivery characteristics; and estimating a first risk score for the first delivery request based on the first set of delivery characteristics in Block S130. In this variation, the method S100 further includes, during a first delivery period within the first period, in response to the first risk score exceeding a first threshold risk score: generating a verification request comprising a first prompt for the first user to confirm the first delivery in Block S140; transmitting the first verification request to a computing device associated with the first user in Block S141; and, in response to receiving confirmation of the first delivery from the first user at the computing device, approving the first delivery request in Block S150. In this variation, the method S100 further includes, during a second period: receiving a second delivery request for a second delivery from the first merchant in Block S110, the first delivery request specifying a second set of delivery characteristics comprising a second delivery type and a second user; estimating a second risk score for the second delivery request based on the second set of delivery characteristics and the risk model in Block S130; and, during a second delivery period within the second period, in response to the second risk score falling below the first threshold risk score, approving the second delivery request in Block S150.

### 2. Applications

Generally, Blocks of the method S100 can be executed by a remote computer system to leverage a user's access to a mobile device (e.g., a smartphone, a smartwatch) to quickly verify a transaction (e.g., a purchase) with a payment method (e.g., a credit card) affiliated with the user before approving this transaction in order to prevent fraudulent transactions with this payment method.

For example, a fraudster may: access information readily available online to identify an owner of a stolen credit card or stolen credit card data (e.g., full name, telephone number, address, zip code, CVC); and initiate a fraudulent credit card transaction in person or online with this stolen credit card or with stolen credit card data and available owner data. Because the fraudster may supply proper billing address and other owner information during this transaction, a credit card processor or bank associated with the stolen credit card may initially interpret this fraudulent transaction as authentic and then approve this transaction in (near) real-time. Because this approval is issued in (near) real-time by the credit card processor or bank, the fraudster may have completed the transaction or many transactions with this stolen credit card or stolen credit card data-all of which may result in loss of money to the bank, credit card processor, and/or credit card owner—by the time the credit card owner notices the fraudulent transaction(s) on a credit card statement or reports the stolen credit card to the credit card processor or bank.

Therefore, the remote computer system (e.g., a remote computer system operated by the user's bank) can execute Blocks of the method S100 to characterize risk of a new transaction with a payment method (e.g., a credit card transaction), such as based on transaction amount, transaction location, and/or merchant. Then, based on the characterized risk of this transaction, the remote computer system can prompt a user-associated with the payment method (e.g., a credit card owner)—to confirm validity of the transaction and set a time limit for receiving confirmation of the transaction from the user via her mobile device. For example, the remote computer system can transmit a text message, push notification (e.g., from a native application), or in-app notification to a mobile device (e.g., a smartphone or smartwatch) linked to the user and/or to the payment method. The user's mobile device can then: prompt the user to swipe right over the prompt to confirm the transaction or swipe left over the prompt to indicate that the transaction is fraudulent; and return the user's response to the remote computer system. Upon receipt of confirmation from the user's mobile device prior to expiration of the time limit, the remote computer system can approve the transaction request and return confirmation of transaction approval to the user's mobile device. However, if the user indicates that the transaction is fraudulent or fails to provide a response to the prompt prior to expiration of the time limit, the remote computer system can deny the transaction request and flag this transaction as (potentially) fraudulent.

Additionally, the remote computer system can enable the user to manage transaction verification and notification settings, such as based on transaction size, time of day, merchant, and/or geographic location. For example, the user may opt out of receiving notifications (e.g., text message notifications) for transactions less than a particular dollar amount (e.g., $20) or for transactions occurring within a particular period of time (e.g., on Saturday from 11 AM to 2 PM while shopping with friends). By enabling the user to adjust notification and user verification settings, the remote computer system can enable the user to assume responsibility (e.g., financial responsibility) for certain transactions or transaction types in exchange for increased user convenience and control. More specifically, the remote computer system can enable the user to exchange a high degree of transaction security (e.g., by requiring transaction confirmation and biometric data for each transaction) and low liability for fraudulent transactions for greater transaction convenience (e.g., by eliminating a confirmation requirement for some or all transactions) and greater liability for fraudulent transactions with a payment method. The remote computer system can thus execute Blocks of the method S100 to enable the user to directly control security, convenience, and personal liability related to use of this payment method.

The remote computer system can thus execute Blocks of the method S100 to: reduce credit card fraud and/or reduce approval of fraudulent transactions by leveraging mobile devices carried by users to confirm authenticity of transactions with their credit cards; govern inconvenience to users by scaling transaction verification efforts according to evaluated risk; enable users to assume some risk from banks or credit card companies in exchange for additional user convenience; increase confidence of financial institutions responsible for verifying these transactions; and increase confidence of credit card users by reducing risk of credit card fraud.

The method S100 is described herein as executed by a remote computer system-such as hosted by a credit card processor, bank, or credit card issuer—to authenticate credit card transactions. However, the remote computer system can execute Blocks of the method S100 to authenticate transactions with other digital and electronic payment methods, such as: wire transactions; NFC payments; and online money transfers. Additionally and/or alternatively, the remote computer system can execute Blocks of the method S100 to authenticate any other type of transaction, such as financial transactions or transfer or delivery of real and virtual goods. Therefore, the method S100 can be executed by a remote computer system-such as hosted by a financial entity (e.g., a credit card processor, bank, or credit card issuer), a merchant, and/or a delivery service—to authenticate transactions.

Further, the method S100 is described herein as executed by a remote computer system, such as including a set of modules (e.g., a transaction request receiving module, a profile identification module, a settings extraction module, a verification request generation module, an identification request generation module, a user communication module, an identification confirmation module, a verification confirmation module, and/or a transaction approval module) executing on a server, a local computer network, and/or a distributed computer network.

### 3. Example

In one example, a user may initiate a transaction with her credit card by swiping the credit card at a merchant terminal. Upon receiving a transaction request corresponding to the transaction initiated by the user, the remote computer system can: extract a set of characteristics corresponding to the transaction request including a credit card number, an identity of the user, an amount of the transaction request, a merchant from which the transaction request was received, and/or a location of the merchant; and estimate a risk score for this transaction based on the set of transaction characteristics.

For example, the computer system can estimate a higher risk value for transactions exceeding a particular dollar amount (e.g., $100, $1,000, 10,000) and a lower risk value for transactions falling below this dollar amount. A bank or intermediary (e.g., credit card company) may specify default dollar amounts that correspond to different risk scores. Alternatively, the remote computer system can implement a user specific model to determine the risk value based on this user's historical transaction data (e.g., whether the user is likely to spend a dollar amount corresponding to the transaction). Similarly, the computer system can determine whether the user is likely to shop at a particular merchant or at a particular geographic location based on the user's previous spending habits and/or based on input provided by the user. The computer system can estimate transaction risk (e.g., a risk score, a transaction score, a probability of fraud) based on these transaction characteristics (e.g., amount, location) or any other relevant data.

In response to the risk score exceeding a first threshold risk score, the remote computer system can prompt the user-via the user's mobile device (e.g., via text message) to verify the transaction. Based on the identity of the first user, the computer system can access a first user profile (e.g., corresponding to the first user), in a set of user profiles, and extract a mobile number stored din the first user profile and associated with the first user. The remote computer system can then deliver (e.g., via text message, via push notification from a native application) the prompt to the user's mobile device. The prompt can include a receipt of the transaction; a call to action, such as “Swipe right if you initiated this transaction or swipe left if you did not initiate this transaction”; and/or an interactive feature (e.g., configured to receive a “swipe right” or “swipe left” input) configured to receive user input. Additionally, upon delivering the prompt to the user, the remote computer system can: set a timer for verification of the transaction to be received; and, in response to receiving verification of the transaction by the user prior to expiration of the timer, approve the transaction request and thereby enable the transaction. Alternatively, in response to expiration of the timer or receiving disconfirmation of the transaction by the user, the remote computer system can deny the transaction request and thereby stop the transaction before it is completed.

Additionally and/or alternatively, in response to receiving this transaction request, the remote computer system can leverage the associated set of transaction characteristics-such as the credit card number—to identify a user profile, from a set of user profiles, associated with the user and previously generated by the user. At the user profile, the remote computer system can access a set of user settings (i.e., user preferences) entered by the user for verifying transactions and/or receiving notifications of transactions initiated with the user's credit card. For example, the user may select a minimum amount (e.g., dollar amount) for receiving verification requests for transactions. Thus, in this example, if the amount of the transaction is less than the minimum amount specified by the user, the remote computer system can automatically verify the transaction. Alternatively, if the amount of the transaction is greater than the minimum amount, the remote computer system can deliver the user a verification request and verify and/or deny the transaction as described above.

Upon receiving verification of the transaction from the user, the remote computer system can approve the transaction request orif the risk score exceeds a second threshold-prompt the user to provide identification data or an identifier (e.g., biometric, passcode). The remote computer system can request: a thumbprint input on a home button of the user's mobile device; a verification code previously provided to the user and unique to the user; and/or answers to a set of questions known to the user or previously entered by the user. Upon receipt of the identification data from the user, the remote computer system can confirm the user's identity based on this data and, if confirmed, approve the transaction request for this transaction.

Once the transaction is approved, the remote computer system can generate a notification to send to the user (e.g., via mobile device) confirming approval and/or completion of the transaction in Block S160. Alternatively, if the remote computer system determines a transaction to be fraudulent and/or denies a transaction request, the remote computer system can similarly generate a notification to send to the user informing the user of the denied transaction.

### 4. Transaction Request

The computer system can receive transaction requests from merchants and extract transaction characteristics to evaluate risk of these transaction requests before approving transactions. In particular, the computer system can receive a transaction request initiated by a first user with a first payment method (e.g., a first credit card) and extract a set of transaction characteristics from the transaction request, such as: a merchant at which the transaction initiated; a geographic location of the merchant (if the transaction initiated at a physical storefront); a URL and/or website at which the transaction initiated (e.g., if the transaction initiated online); an amount of the transaction (e.g., a dollar amount); a payment identifier (e.g., credit card number) associated with the first payment method; and/or an identity of the first user associated with the first payment method.

Additionally, in response to receiving a transaction request and extracting transaction characteristics from this transaction request, the remote computer system can identify the first user (e.g., based on the payment identifier) specified in the set of transaction characteristics. Upon identifying the first user, the remote computer system can access a user profile in a set of user profiles associated with the first user and extract a mobile phone number of the first user based on the identity of the first user, the user profile containing identifying information (e.g., full name, address, mobile phone number, email address, etc.) of the first user.

In one implementation, upon receiving a transaction request, the computer system can: identify a payment identifier (e.g., a credit or debit card number, a routing number) associated with the transaction request; access a set of user profiles, each user profile in the set of user profiles associated with a particular user (e.g., credit card owner) or set of users; and identify a first user profile, in the set of user profiles, corresponding to a first user associated with the payment identifier.

Upon identifying the first user, the remote computer system can then access a first user profile (e.g., stored in a database, populated by the user via a native application) corresponding to the first user and extract a set of identifying characteristics of the first user for verification of the transaction request. For example, the remote computer system can extract: full name; date of birth; biometric data (e.g., fingerprint data, facial recognition data); a passcode unique to the user; answers to identifying questions (e.g., “what is your mother's maiden name?,” “what street did you grow up on?,” “What was the name of your first pet?”); etc. Therefore, based on the transaction characteristics and these identifying characteristics of the user, the remote computer system can selectively generate and serve transaction verifications to the user.

In another variation, upon extracting the set of transaction characteristics, the computer system can: access historical transaction characteristics of the first user with the first credit card representing past transactions initiated by the first user; compare the set of transaction characteristics to the user's historical transaction characteristics; and estimate a risk score for the transaction request based on this comparison. Therefore, the computer system can access historical transaction characteristics associated with legitimate transactions initiated by a user to inform risk characterization for future transactions initiated by the user.

For example, upon receiving a transaction request from a merchant, the transaction request associated with a first credit card, the computer system can: access a set of user profiles—as provided by a financial institution (e.g., an acquiring bank, a processor of the acquiring bank, or a credit card issuer) associated with the first credit card—to identify a first user (e.g., cardholder) corresponding to a first user profile in the set of user profiles associated with the first credit card; access a set of transaction characteristics for the transaction request including a dollar amount, the merchant from which the transaction request initiated, and the location of the merchant (e.g., geographic location, URL); compare the set of transaction characteristics with a series of transaction characteristics representing past transactions initiated by this user via the first credit card; estimate a risk score for the transaction request based on this comparison between the current set of transaction characteristics and historical transaction characteristics of this user. The computer system can then notify the user of the transaction request and either approve or deny the transaction request based on the estimated risk score and/or feedback provided by the user. If the risk score is low (e.g., as defined by an associated financial institution), the computer system can automatically approve the transaction request and notify the user of the completed transaction (e.g., via a text message sent to the user's mobile device). If the risk score is relatively high, the computer system can notify the user of the pending transaction request and prompt the user to provide confirmation of the transaction request, before approving the transaction request. Therefore, the computer system can automatically approve lower risk transactions without further investigation and investigate higher risk transactions corresponding to irregular user transactions or meeting some defined risk threshold (e.g., meeting a minimum dollar amount) to ensure legitimacy of transactions allegedly initiated by the user (e.g., credit card owner).

### 4.1 Transaction Backend

As shown in FIG. 1, the computer system can receive a transaction request from a merchant at which a transaction associated with the transaction request was initiated. Generally, a user (or merchant) may initiate a transaction by swiping a credit card at a checkout terminal, and the checkout terminal then reads an account number and/or other identifying data encoded on a magnetic strip or chip of the user's credit card. After successful reading of the credit card by the checkout terminal, the checkout terminal generates a transaction request and transmits the transaction request—along with details of the transaction (e.g., credit card information, merchant, amount, time, location)—to an acquiring bank of the merchant or to a processor (e.g., intermediary) associated with the acquiring bank for verification of credit card and user information.

The acquiring bank then transmits the transaction request to a credit card network (e.g., Visa, Mastercard), which then routes the transaction request to an issuing bank associated with the credit card and account number (e.g., the bank from which the user obtained the credit card). Upon receiving the transaction request, the issuing bank can—in combination with the remote computer system-implement Blocks of the method S100 to verify the identity of the user initiating the transaction before approving the transaction. If the issuing bank confirms the identity of the user (e.g., via the remote computer system) and authorizes (or approves) the transaction request, the issuing bank transmits the authorized transaction request back to the credit card network, which may then route this authorized transaction request back to the acquiring bank. The acquiring bank may then transmit the authorized transaction request back to the merchant terminal, which can then finalize the transaction accordingly.

Similarly, the user may manually enter credit card information during online checkout for an online purchase with a merchant, and a virtual checkout terminal can generate a transaction request and transmit the transaction request-along with details of the transaction (e.g., credit card information, merchant, amount, time, location)—to the acquiring bank of the merchant or to the processor associated with the acquiring bank for verification of credit card and user information. The acquiring bank can then repeat the foregoing process according to Blocks of the method S100 to confirm the transaction and return authorization of the transaction request back to the virtual merchant terminal.

Therefore, the remote computer system can execute Blocks of the method S100 in (near) real-time to approve or deny transaction requests, such as within two minutes of initiation of the transaction.

In one implementation, the remote computer system can: receive transaction requests from a financial entity associated with a particular payment method (e.g., credit card) via a banking portal; verify authenticity of these transaction requests according to Blocks of the method S100; and transmit approved and/or denied transaction requests back to the financial entity via the banking portal.

For example, a user may initiate a transaction at a merchant (e.g., online or in-person) with a payment method (e.g., credit card) specifying a payment identifier (e.g., credit card number). A checkout terminal associated with the merchant then generates a transaction request for this transaction which is then routed toward a financial entity (e.g., acquiring bank, credit card processor, issuing bank) associated with the payment method and the payment identifier. The remote computer system can then receive the transaction request from the financial entity via an instance of a banking portal accessed by the financial entity. In particular, in this example, a transaction request receiving module can receive the transaction request from the financial entity, via the instance of the banking portal, and sort the transaction request (e.g., by timestamp received) in a set of transaction requests received via the instance of the banking portal.

The transaction request receiving module can then route the transaction request toward a series of additional modules (e.g., a profile identification module, a settings extraction module, a verification request generation module, an identification request generation module, a user communication module, an identification confirmation module, a verification confirmation module) configured to verify authenticity of the transaction request. A transaction approval module can then approve or deny the transaction request. In this example, in response to identifying the transaction request as an approved transaction request (e.g., by the transaction approval module), a transaction request transmitting module can deliver the approved transaction request back to the financial entity via the instance of the banking portal.

### 5. Risk Characterization

Upon receiving a transaction request including a set of transaction characteristics (e.g., user, credit card, merchant, amount, location), the remote computer system can characterize the risk (e.g., level of risk) associated with this transaction based on the set of transaction characteristics.

In one implementation, the remote computer system can characterize risk by risk levels, such as “low-risk,” “moderate-risk,” or “high-risk.” In one example, the remote computer system can characterize risk according to risk levels and based on an amount of a transaction, such as: classifying transactions exceeding $1,000 as high-risk transactions; classify transactions exceeding $100 and falling below $1,000 as moderate-risk transactions; and classifying transactions falling below $100 as low-risk transactions. In another example, the remote computer system can characterize risk according to risk level and based on a geographic location of the transaction, such as: characterize transactions initiated within a 20-mile radius of a user's home address as low-risk transactions; characterize transactions initiated outside the 20-mile radius but within a 200-mile radius of the user's home address as moderate-risk transactions; and characterize transactions initiated outside the 200-mile radius as high-risk transactions. Alternatively, the remote computer system can characterize risk as a function of both the dollar amount of a transaction and a geographic location at which the transaction initiated.

In another example, the remote computer system can characterize the risk of a transaction based on a location of the user's mobile device relative to a location at which the transaction initiated. For example, in response to receiving a transaction request associated with a user, the remote computer system can: access a user profile, in a set of user profiles, associated with the user to identify a mobile device associated with the user; access geospatial data from the mobile device to identify a first location (e.g., near real-time location) of the mobile device (e.g., which may correspond to a location of the user); identify a second location (e.g., geographic location) at which the transaction request initiated; and calculate a distance between first location and the second location. Then, the remote computer system can characterize the risk of the transaction based on this distance, such as: characterize the transaction as “low” risk in response to the distance falling below a first distance threshold (e.g., 0.1 miles); characterize the transaction as “moderate” risk in response to the distance falling exceeding the first distance threshold and falling below a second distance threshold (e.g., 5 miles); and characterize the transaction as “high” risk in response to the distance exceeding the second distance threshold.

Thus, the remote computer system can characterize the risk level of a transaction based on any transaction characteristic and/or any combination of transaction characteristics. Furthermore, the remote computer system can define additional, fewer, and/or alternative risk levels.

In another implementation, the remote computer system can characterize risk as a probability (e.g., 10%, 50%, 90%) that the transaction is fraudulent. The remote computer system can calculate this probability as a function of the set of transaction characteristics received with the transaction request. The remote computer system can implement different security measures based on this probability. For example, if a probability of 90% is calculated for a transaction, the remote computer system can serve the user a verification request including: a prompt to confirm or disconfirm the transaction; a request for a biometric (e.g., fingerprint) of the user; and/or a request for an 8-digit passcode known by the user. Alternatively, if a probability of 1% is calculated for the transaction, the remote computer system can automatically approve the transaction and serve the user a notification that the transaction occurred.

### 5.1 Risk Model

In one implementation, the remote computer system can access a risk model configured to intake the set of transaction characteristics for the transaction and output a risk score. The remote computer system can access a generic risk model, a risk model defined by a particular financial institution (e.g., bank, credit card company) associated with the transaction, and/or a user specific risk model.

In one variation, the remote computer system can access a risk model defined by the financial institution (e.g., bank or credit card company) associated with the transaction and the user. A financial institution may upload this predefined risk model to the remote computer system for evaluating risk of future transactions. Additionally, the financial institution may define a set of risk models and upload each of these to the remote computer system. For example, a bank may define a first risk model for users with “good” credit scores (e.g., credit scores equal to or greater than 680) and a second risk model for users with “bad” credit scores (e.g., credit scores lower than 680). The bank may upload this set of risk models to the remote computer system. Then, when a transaction request is received, the remote computer system can: extract a set of transaction characteristics for this transaction request to identify a user associated with the transaction request; access a user profile including the user's credit score; and, in response to the user profile specifying a credit score of 690, access the first risk model and calculate a risk score for this transaction based on the set of transaction characteristics and the first risk model.

In one variation, a financial institution (e.g., bank, credit card company) associated with the credit card of the user may specify definitions and/or parameters for defining levels of risk. The remote computer system can apply these definitions to generate a risk model for estimating risk of transactions. For example, a first bank may define a first risk definition defining: transactions exceeding $1,000 as high-risk transactions; transacting exceeding $100 and falling below $1,000 as moderate-risk transactions; and transactions falling below $100 as low-risk transactions. Alternatively, a second bank may define a second risk definition defining risk on a scale of 0 to 100 as a function of transaction amount, user transaction history, and merchant. The remote computer system can estimate risk according to the first definition for customers of the first bank and according to the second definition for customers of the second bank.

In one variation, the remote computer system can access a user specific model configured to intake a set of transaction characteristics and to output a risk score for a transaction initiated by a particular user. For example, as a user confirms and disconfirms transactions over time, the remote computer system can “learn” typical spending habits or transaction characteristics associated with this user. The remote computer system can learn user spending habits such as: average transaction amount; average total daily transaction amount; frequent merchants; average geographic location (e.g., average radius); maximum transaction amount; habitual transactions; etc. The remote computer system can then leverage this information when estimating risk of transactions for this particular user.

### 6. Transaction Verification

Upon estimating a risk score of the transaction, the remote computer system can execute Blocks of the method S100 to verify validity of the transaction. For example, in response to the risk score exceeding a threshold risk score, the remote computer system can prompt the user (e.g., via a text message sent to the mobile device of the user) to verify the transaction. The remote computer system can generate a verification request including a summary of the transaction (e.g., merchant, amount, time) and a prompt that reads: “Did you initiate this transaction? If yes, swipe right. If no, swipe left.” The verification request can include a responsive element configured to receive a “swipe right” or a “swipe left” input from the user below the prompt. Additionally, the remote computer system can attach a summary of the transaction (e.g., merchant, amount, time, etc.). Therefore, the user may swipe right on the responsive element of the verification request to indicate that she initiated this transaction and thus verify the validity of the transaction or swipe left to indicate that she did not initiate the transaction.

In one variation, the remote computer system can request an identifier (e.g., biometric, passcode, response to a user-specific question) from the user in order to confirm the identity of the user and thus verify the transaction. For example, the remote computer system can prompt the user to provide a thumbprint (e.g., on a button or screen of the user's mobile device) or prompt the user to position a forward-facing camera of the user's mobile device toward the user's face for identification of the user via facial recognition software. Upon receipt of this biometric from the user, the remote computer system can compare data of this biometric to data previously obtained from the user and confirm the user's identity. In another example, the remote computer system can request a passcode from the user in order to confirm the identity of the user before verifying the transaction. At an initial time, the remote computer system can provide the passcode to the user. Alternatively, the remote computer system can prompt the user to generate a passcode for transactions. Upon receipt of the passcode from the user, the remote computer system can compare this passcode to the saved passcode. In yet another example, the remote computer system can prompt the user with a series of questions about the user. The remote computer system can implement identifying questions corresponding to responses that only the user may be able to provide and/or can initially prompt the user to provide answers to a series of questions selected by the remote computer system or the user. In each of these examples, the remote computer system can receive the identifier from the user and confirm the identity of the user based on stored identifiers contained in the user profile.

The remote computer system can implement different types or combinations of types of user verification corresponding to different levels of security based on the estimated risk score for a transaction. For example, the remote computer system can estimate a risk score of 90% for a transaction, corresponding to a 90% probability that the transaction is fraudulent. Based on this relatively high risk score, the remote computer system can: send a verification request (e.g., to a mobile device of the user) prompting the user to confirm or disconfirm the transaction; and, in response to the user confirming the transaction, prompt the user to input a biometric (e.g., a thumbprint, a live image of her face). If the biometric matches a control biometric of the user (e.g., as confirmed by her mobile device), the remote computer system can receive verification of the transaction and approve the transaction request. Alternatively, if the remote computer system estimates a risk score of 5% for the transaction, corresponding to a relatively low 5% probability that the transaction is fraudulent, the remote computer system can: send the verification request to the user, prompting the user to confirm or disconfirm the transaction; and, in response to receiving confirmation of the transaction from the user, approve the transaction request without any further required input from the user.

In one implementation, the remote computer system can characterize transactions as low-risk, medium-risk, or high-risk. For each of these risk types, the remote computer system can implement a different process for notification and verification of transactions. For example, in response to characterizing a transaction as a low-risk transaction, the remote computer system can send a notification to the user (e.g., via mobile device) including a receipt of the transaction. In response to characterizing a transaction as a moderate-risk transaction, the remote computer system can send a notification to the user and prompt the user to confirm the transaction (e.g., by swiping right on the screen of her mobile device) or dispute the transaction (e.g., by swiping left on the screen of her mobile device). In response to characterizing a transaction as a high-risk transaction, the remote computer system can: send a notification to the user; prompt the user to confirm the transaction or dispute the transaction; and prompt the user to provide biometric confirmation (e.g., thumbprint, facial recognition) to confirm the identity of the user.

Therefore, the remote computer system can employ different security measures for verification of transactions according to risk. The remote computer system can assess the risk associated with each transaction request received and—based on this risk—determine appropriate action for verifying the transaction and approving the transaction request, such as implementing additional security for higher risk transactions and implementing minimally invasive security for lower risk transactions.

In one variation, the remote computer system can initiate a timer upon sending the verification request to the user, such that the user must confirm the transaction within a set duration (e.g., 30 seconds, 1 minute, 5 minutes). For example, the remote computer system can: send a verification request to the user prompting the user to confirm or disconfirm (i.e., deny) the transaction; and approximately concurrently initiate a timer for 1 minute. Then, in response to receiving confirmation of the transaction from the user before expiration of the timer, the remote computer system can approve the transaction request. Alternatively, in response to expiration of the timer before receiving confirmation of the transaction from the user, the remote computer system can deny the transaction request. In this variation, the remote computer system can include a display of the timer with the verification request such that the user may view the timer. By including a timer, the remote computer system enables approval or denial of the transaction request in (near) real-time by necessitating an immediate or quick response from the user.

In this variation, in response to expiration of the timer prior to receiving confirmation of the transaction from the user, the remote computer system can enable the user to attempt the transaction a second time. For example, the user may forget to check her mobile device and/or miss the verification request transmitted to the user by the remote computer system. Then, in response to expiration of the verification request (e.g., linked to a timer for a set duration) prior to receiving confirmation of the transaction from the user, the computer system can deny the transaction request. The computer system can then generate an additional prompt for the user to provide an identifier (e.g., biometric, passcode), thereby enabling the user to attempt the transaction a second time. The user may be more likely to view this additional prompt after her first attempt at the transaction is denied.

### 6.1 Finalize Transaction

Once verification of the transaction has been received from the user, the remote computer system can approve the transaction request. Alternatively, if verification of the transaction is not received, the remote computer system can deny the transaction request. The remote computer system can transmit the denied transaction request to the credit card network where it may be routed back through the pipeline and finally back to the merchant or merchant terminal.

Once the transaction is approved, the remote computer system can generate a notification to send to the user (e.g., via mobile device) confirming approval and/or completion of the transaction. Alternatively, if the remote computer system determines a transaction to be fraudulent and/or denies a transaction request, the remote computer system can similarly generate a notification to send to the user informing the user of the denied transaction.

### 7. User Profiles

In one variation, the remote computer system can store information obtained during a transaction in a user profile (e.g., a user profile stored in a remote database). For example, upon receiving confirmation of a transaction from a user, the computer system can store the set of transaction characteristics for the approved transaction at the user profile.

The remote computer system can discard data from disconfirmed or unverified transaction requests. Alternatively, the remote computer system can store transaction characteristics from all transaction requests at the user profile. For example, the remote computer system can store confirmed transactions at a first location in the user profile and disconfirmed transactions in a second location at the user profile.

In one variation, the remote computer system can leverage data contained in the user profile (e.g., transaction characteristics for confirmed and/or disconfirmed transactions) to generate a user-specific transaction model for characterizing transaction risk. As a user confirms and disconfirms transactions over time, the remote computer system can “learn” typical spending habits or transaction characteristics associated with this user and store this information at this user's profile. The remote computer system can learn user spending habits such as: average transaction amount; average total daily transaction amount; frequent merchants; average geographic location (e.g., average radius); maximum transaction amount; habitual transactions; etc. For example, a user may frequently shop (e.g., daily, weekly, monthly) online from a particular merchant, with an average transaction amount of $1,000 between this user and this particular merchant. Upon receiving a transaction request and a set of transaction characteristics specifying this user, this particular merchant, and a transaction amount of $850, the remote computer system can: access the user profile; access a user-specific transaction model linking the set of transaction characteristics to transaction risk for this user; predict low transaction risk for this transaction request based on the user-specific transaction model and the set of transaction characteristics; and verify the transaction request according to protocol for low risk transactions.

### 8. User Controls

In one variation, the user may access a set of user controls configured to enable the user to specify different settings for notification and verification of transactions. For example, the remote computer system can host or interface with a user portal (e.g., via native application or web application)—executing on a user's computing device (e.g., a mobile device, a computer)—to configure a user profile for the user.

For example, the user may download the native application to her smartphone and create a new user profile. In particular, in this example, the user may download the native application to her smartphone and create a new user profile. The remote computer system can then prompt the user to provide and/or verify identifying information (e.g., answers to a set of security questions, facial identification, photo identification, driver's license number) for the user. Once the user provides this information, the remote computer system can verify an identity of the user creating the new user profile by comparing the information provided by the user via the native application with previously received identifying information of the user (e.g., from a bank associated with a payment method owned by the user). Once the identity of the user is verified, the computer system can link the new user profile-accessible to the user via the native application executing on the user's smartphone—to the user. The user may then manually populate the new user profile with various information, such as: name, social security number, contact information (e.g., phone number, email address, mailing address), credit card account(s), checking account(s), user demographics, user spending habits, etc.

Additionally, the user may elect to modify the default notification and verification settings. For example, a user may elect to only require user verification for transactions exceeding a particular dollar amount. In another example, a user may elect to disable notifications and user verification for a 24-hour period.

By enabling the user to adjust notification and user verification settings, the remote computer system enables the user to assume responsibility (e.g., financial responsibility) for certain transactions or transaction types in exchange for increased convenience. For example, if the user elects to require user verification only for transactions exceeding $100, the remote computer system can automatically approve transaction requests for transactions less than $100. However, in this example, if the remote computer system automatically approves a transaction request for $95 initiated by a fraudster in possession of the user's credit card, the user may ultimately be financially liable for the transaction. However, if the user maintains the default settings for notifications and user verification (e.g., always require user verification), a bank or credit card company associated with the user's credit card account may be financially liable for fraudulent transactions, rather than the user.

Therefore, the remote computer system enables the user to set and/or adjust these verification settings based on the user's preferences while limiting financial liability to the bank or credit card company associated with the user's credit card account. In one example, a bank associated with the user's payment method may initially specify (e.g., via a banking module) a default threshold transaction value for which: transactions associated with transaction values below the default threshold transaction value do not require verification (e.g., the bank may be financially liable for any fraudulent transactions); and transactions associated with transaction values exceeding the default threshold transaction require verification. In this example, the bank may be financially liable for any fraudulent transactions associated with transaction values below the default threshold transaction value. However, during initial setup of a user profile for the user (e.g., at a mobile device of the user via a user portal), the remote computer system can enable the user to adjust this default transaction value. In particular, in this example, the computer system can render an interface with a toggle switch on a touch-screen display of the mobile device, enabling the user to adjust a pointer along the toggle switch corresponding to a user threshold transaction value. Then, in response to the user selecting a first threshold transaction value exceeding the default threshold transaction value, the remote computer system can: render a prompt to accept responsibility for financial loss for transactions with transaction values falling between the default threshold transaction value and the first threshold transaction value; and request an identifier (e.g., thumbprint) from the user to confirm the first threshold transaction value.

Additionally and/or alternatively, in response to the user selecting the first threshold transaction value, the remote computer system can serve to the user an electronic contract for disabling verification of transactions with transaction values below the first threshold transaction value and for assuming liability for transactions with transaction values between the default threshold transaction value and the first minimum transaction value. Then, in response to execution of the electronic contract by the user, the remote computer system can replace the default threshold transaction value with the first threshold transaction value specified by the user.

In one implementation, the remote computer system can: receive a transaction request associated with a user and specifying a particular transaction value; access the user profile associated with the user to identify a set of threshold transaction values defined by the user; and select an appropriate verification method based on the particular transaction value and the set of threshold transaction values defined by the user. For example, in response to receiving a transaction request for a transaction associated with a user and specifying a first transaction value and a first payment identifier, the remote computer system can: access a user profile, in a set of user profiles, associated with the user based on the first payment identifier; and identify a first threshold transaction value, stored in the user profile, representing a minimum transaction value for which the user wishes to receive transaction verification requests. Therefore, in response to the first transaction value falling below the first threshold transaction value, the remote computer system can: automatically verify the transaction request; and notify the user of the approved transaction via her mobile device. Alternatively, in response to the first transaction value exceeding the first threshold transaction value, the remote computer system can: generate a verification request for the user to confirm initiation of the transaction; transmit the verification request to the user at her mobile device; and, in response to receiving confirmation of the verification request from the user, approve the verification request.

Alternatively, in the preceding example, the remote computer system can similarly identify a second threshold value, stored in the user profile, representing a minimum transaction value for which the user wishes to receive identification verification requests. Therefore, in response to the first transaction value exceeding the first threshold transaction value, the remote computer system can: generate an identification verification request for the user to input an identifier (e.g., biometric, passcode) in response to receiving confirmation of the verification request; transmit the identification verification request to the user at her mobile device; and, in response to receiving a first identifier corresponding to a target identifier stored in the user profile, approve the verification request.

In one variation, the remote computer system can: identify a threshold transaction value defined by the user for verifying transaction; and characterize risk for transactions with transaction values exceeding this threshold transaction value. For example, in response to receiving a first transaction request for a first transaction associated with a user and specifying a first transaction value of $25, the remote computer system can: access a user profile associated with the user to identify a first threshold transaction value of $50, representing a minimum transaction value for which the user wishes to receive transaction verification requests. Therefore, the remote computer system can automatically approve the first transaction request. Later, in response to receiving a second transaction request for a second transaction associated with the user and specifying a second transaction value of $100, the remote computer system can: extract a set of transaction characteristics (e.g., a payment method, a merchant, online or in-store transaction, the second transaction value, time of day) for the second transaction request; access a risk model (e.g., defined by a financial entity associated with the payment method); and characterize a risk of the second transaction based on the risk model and the set of transaction characteristics. The remote computer system can then leverage this risk to identify a method for verifying the second transaction request.

### 8.1 Verification Settings

The user may elect to change notification and verification settings from default settings to personal settings, which may be more convenient to the user. For example, in response to characterizing a transaction as a low-risk transaction, the remote computer system can send a notification to the user (e.g., via mobile device) including a receipt of the transaction. In response to characterizing a transaction as a moderate-risk transaction, the remote computer system can send a notification to the user and prompt the user to confirm the transaction (e.g., by swiping right on the screen of her mobile device) or dispute the transaction (e.g., by swiping left on the screen of her mobile device). In response to characterizing a transaction as a high-risk transaction, the remote computer system can: send a notification to the user; prompt the user to confirm the transaction or dispute the transaction; and prompt the user to provide biometric confirmation (e.g., thumbprint, facial recognition) to confirm the identity of the user. However, the user may decide she does not want to receive notifications for low-risk transactions and update controls within her user profile accordingly. Subsequently, the remote computer system can withhold notifications for low-risk transactions with the user's credit card and only transmit requests for verification of moderate-risk and high-risk transactions to the user. Alternatively, the user may specify she does not want to verify moderate-risk transactions. By enabling the user to disable verification of moderate-risk transactions, the remote computer system enables the user to shift financial liability for these moderate-risk transactions onto herself in exchange for increased convenience to the user as she no longer must verify each transaction characterized as a moderate-risk transaction.

### 8.2 User Parameters

In one variation, the user may input a set of user settings that specify particular transaction characteristics that enable automatic verification of transactions. For example, a user may specify a minimum amount (e.g., dollar amount) of a transaction for which the user wishes to receive notifications and/or require verification of transactions. In this example, the user may wish to disable all notifications and verification requests for any transaction request less than $20. The user may access the user portal and input a first user setting specifying a minimum transaction amount of $20 for receiving notifications and verification requests from the remote computer system. Later, in response to receiving a transaction request associated with the user, the remote computer system can: access a set of transaction characteristics for the transaction specifying the user, an amount of $18.50, and a geographic location of London, U.K.; and access a first user profile in a set of user profiles, the first user profile corresponding to the user and specifying the first user setting. Although the first user profile may also specify the user's address as Grand Marais, MN, U.S.A., the remote computer system can automatically approve the transaction request based on the first user setting. Therefore, in this example, the first user may assume the risk of automatically approving potentially fraudulent transactions (e.g., if the particular user did not initiate the transaction in London) in exchange for the convenience of not receiving notifications or needing to verify “everyday” transactions (e.g., transactions less than $20). Alternatively, in this example, for further protection against fraudulent activity, the user may specify a minimum transaction amount of $20 unless a transaction occurs outside of a 500-mile radius from Grand Marais, MN or outside of the United States.

In another example, the user may input a particular location (e.g., geographic location, geographic region, a particular merchant) for which to disable notifications of transactions and/or verification requests. In this example, the user may wish to disable all notifications and verification requests for any transaction initiated at a particular coffee shop the particular user visits frequently. The user may access the user portal and input a first user setting disabling notifications and verification requests for transactions initiated at the particular coffee shop. Later, in response to receiving a transaction request associated with the user, the remote computer system can: access a set of transaction characteristics for the transaction specifying the user, an amount of $50, and the particular coffee shop as the merchant; access a first user profile corresponding to the user and specifying the first user setting; and, in response to the first user profile specifying the first user setting, automatically approve the transaction request. In this example, although the remote computer system may otherwise—in some cases-characterize the transaction request as a moderate-risk transaction (e.g., based on a predefined risk definition or risk model), the remote computer system can bypass characterizing a risk score of the transaction request based on the first user setting specified in the first user profile and automatically approve the transaction request. Therefore, the remote computer system can apply user settings as set forth by a user in her user profile to bypass risk estimations and automatically approve transactions according to these user settings. Alternatively, the user may elect to increase security measures by requiring user verification for all transactions, regardless of transaction risk (e.g., whether a transaction is “low risk” or “high risk”).

### 8.3 Temporary Settings

In one variation, a user may elect to input short-term changes in notification and verification request settings for a set period of time (e.g., 2 hours, 12 hours, 24 hours). For example, in preparation for a work dinner with the user's employees and clients, the user may elect to disable notifications and verification requests for a set period of time (e.g., 3 hours) during the dinner. The remote computer system enables the user to purchase food and drinks for her employees and clients throughout the evening without the inconvenience of checking her phone and approving transactions.

In another example, the user may lend her credit card to a second user (e.g., a child of the user). The user may elect to receive verification requests for all transactions occurring over a set period of time while the second user is in possession of the user's credit card. Thus, if the user plans to lend her credit card to her child for an afternoon, the user may access the user portal and input a temporary setting to enable verification requests for all transactions for the afternoon (e.g., 4 hours, the rest of the day). Therefore, the remote computer system enables the user to effectively approve or deny transactions initiated by her child while in possession of the user's credit card. Additionally and/or alternatively, the user may elect to disable verification requests and/or notifications for all transactions occurring while the second user is in possession of the credit card. Therefore, the remote computer system enables the user to permit other users to initiate transactions with her credit card (e.g., without user verification) in circumstances when the user may not be available to check her phone or otherwise confirm transactions, such as if the user is in a meeting at work.

The user may also update her current geographic location (e.g., city) or input a geographic location for a particular date range in the future. For example, if the user plans to go to Europe for two weeks, the user may access the user portal and input the dates corresponding to her vacation in Europe and specify the countries she plans to visit. Therefore, the remote computer system can automatically update the user's location to these countries while the user is in Europe, and minimize inconvenience to the user while travelling.

In another example, the user may temporarily enable a second user to receive and approve or deny transaction requests. In this example, the user may access the user portal and input a temporary setting to enable sending of verification requests to a second user (e.g., via the second user's mobile device). Therefore, if the user is unavailable to confirm or deny a transaction, the remote computer system can still approve the transaction request by receiving confirmation of the transaction from the second user.

### 8.4 Multiple Users

In one variation, the remote computer system can enable multiple users to verify transactions for a single credit card. For example, the user may share a credit card with her spouse. The user may access the user portal and add her spouse as a second user of the credit card in the user profile, specifying her spouse's name and mobile phone number. Later, in response to receiving a transaction request specifying this user and credit card, the remote computer system can: access the user profile; in response to the user profile specifying both the user and her spouse as owners of the credit card, extract contact information for each user; and send a verification request for the transaction to both the user and her spouse. The remote computer system can then approve the transaction request if either the user or her spouse confirm the transaction.

In another variation, the remote computer system can selectively serve verification requests to multiple users sharing a credit card based on transaction characteristics. For example, the user may share an account for an online retailer (e.g., Amazon) with her spouse. The user may specify that notifications and/or verification requests for any transactions occurring at this particular merchant, the online retailer, be sent to both the user and her spouse. Alternatively, the user may specify that all notifications and verification requests for transactions occurring at a first merchant be sent to the user, while all notifications and verification requests for transactions occurring at a second merchant be sent to her spouse. In another variation, the remote computer system can selectively serve verification requests to multiple users sharing a particular payment method (e.g., credit card) based on geospatial data from mobile devices of these users. For example, in response to receiving a transaction request specifying a first payment method, the remote computer system can: access a user profile associated with the payment method; and identify a first and second user associated with the payment method and a first and second mobile device associated with the first and second user, respectively. To determine which user initiated the transaction, the remote computer system can: access a primary location (e.g., geographic location) at which the transaction was initiated (e.g., at a store-front of a merchant, online at the user's home); access a first location associated with the first mobile device of the first user; and calculate a first distance between the primary location and the first location. Further, the remote computer system can: access a second location associated with the second mobile device of the second user; and calculate a second distance between the primary location and the second location. In response to the first distance falling below the second distance, the remote computer system can generate and transmit a verification request to the first user at the first mobile device.

Alternatively, in the preceding example, in response to both the first and second distance exceeding a threshold distance (e.g., 20 miles), the remote computer system can: generate and transmit a verification request to both the first and second users at the first and second mobile devices; and (approximately) concurrently transmit a notification to both mobile devices to alert the first and second users of a potential and/or likely fraudulent transaction.

### 9. Delivery Verification

As described above, the remote computer system can verify an identity of a user in order to approve financial transactions initiated by this user. The remote computer system can implement similar methods and techniques to verify an identity of a user in order to approve other transaction types, such as non-financial transactions (e.g., delivery of physical goods).

In one variation, as shown in FIG. 4, the remote computer system can verify an identity of a user in order to approve a delivery transaction (hereinafter a “delivery”), such as a delivery of physical goods to this user. In this variation, the remote computer system can receive a delivery transaction request (or “delivery request”) for an order initiated by a user and extract or retrieve a set of delivery transaction characteristics (hereinafter “delivery characteristics”) associated with the delivery request, such as: an identity of the user; a product type specified in the order; a merchant (e.g., grocery store, pharmacy, an e-commerce retailer, a third-party delivery service) fulfilling the order; a destination (e.g., a street address) at which the order is scheduled for delivery; a geographic location of the merchant and/or the user; a URL and/or a website at which the order was initiated (e.g., if the order was initiated online); and/or an amount (e.g., a dollar amount) of the order. Based on these order characteristics, the remote computer system can characterize risk for delivery of this order. Based on the risk of the delivery, the remote computer system can implement a series of security measures (e.g., requesting a passcode, requesting a biometric, serving a series of security questions) configured to verify the identity of the user receiving the delivery and thus verify validity of the delivery.

The remote computer system can enable the user to manage delivery verification and notification settings, such as based on a type of product or an amount (e.g., a dollar amount) of a purchase (or “basket”) associated with the delivery. By enabling the user to adjust these settings, the remote computer system can enable the user to assume greater responsibility for these deliveries in exchange for increased user convenience and control of receiving deliveries- and vice versa. Further, the remote computer system can streamline operation for merchants and/or third-party delivery services and reduce rate of failed delivery attempts by: ensuring that designated users receive their deliveries; verifying receipt of deliveries with users in real-time; preventing lost or stolen deliveries; and/or reducing liability of merchants and/or third-party delivery services for lost or stolen deliveries when users opt out of greater security settings in exchange for greater delivery flexibility.

### 9.1 Example

In one example, a user may speak with her physician to request a prescription for a medication. The user's physician may approve and transmit the prescription to a pharmacy specified by the user for filling and delivery of the medication to the user. Then, in response to the pharmacy receiving the prescription from the user's physician, the remote computer system can: receive a delivery request associated with the prescription from the pharmacy; extract a set of delivery characteristics of the delivery request including a user identity, a merchant (e.g., the pharmacy) from which the delivery request initiated, a type of product(s) (e.g., medication) associated with the delivery request, a drug classification (e.g., schedule II, III, IV, or V) specified in the prescription, a location (e.g., address) for delivery of the medication to the user, and a dollar amount associated with the delivery request; and access a user profile, in a set of user profiles, associated with the user based on the user identity extracted from the delivery request, wherein the user profile includes contact information (e.g., a phone number, an email address) of the user.

The remote computer system can then transmit a notification (e.g., a receipt of the transaction request) to the user (e.g., via text message, via push notification, via a native application executing on the user's mobile device) informing the user that the transaction request was received by the pharmacy, such as “Your prescription has been received and is being prepared by Pharmacy X.” The remote computer system can also inform the user of an estimated availability window (e.g., spanning a 48-hour period, spanning one week) during which the medication may be available for delivery to the user.

The remote computer system can prompt the user to elect and/or input a set of delivery settings for this particular transaction request, such as: a list of secondary users who may receive the delivery on behalf of the user if the user in unavailable to receive the delivery in person; a particular delivery window (e.g., “Monday: 7 AM-4 PM”), from a set of available delivery windows (e.g., “Monday: 7 AM-3 PM,” “Monday: 3 PM-10 PM,” “Tuesday: 7 AM-3 PM,” and Tuesday: “3 PM-10 PM”) during which the medication may be delivered to the user and that may be more convenient for the user; and/or a set of user verification settings (e.g., default settings, maximum security settings, minimum security settings) for confirming identity of the user and/or other users elected by the user when approving the transaction request and therefore complete the delivery of the prescription to the user. The remote computer system can then store these delivery settings for this transaction request at the user profile.

The remote computer system can also estimate a risk score for this delivery based on the set of delivery characteristics. In particular, in this example, the remote computer system can estimate a higher risk score for deliveries including Schedule II and/or Schedule III drugs and a lower risk score for deliveries including Schedule III and/or Schedule IV drugs. Alternatively, the remote computer system can estimate a higher risk score for deliveries including any medications and a lower risk score for deliveries including non-restricted items (e.g., meals, groceries, clothing, home goods). Alternatively, the remote computer system can implement a user-specific risk model to estimate a risk score for the delivery based on the user's preferences (e.g., as specified in the user profile). The remote computer system can store this risk score for this delivery at the user profile and leverage the risk score to select a set of verification settings for this delivery.

The remote computer system can transmit a series of status updates to the user regarding the delivery, such as an up-to-date estimated delivery time. Additionally, the remote computer system can notify the user of updates to the risk score and/or verification settings for this delivery, such as while the delivery is being prepared or while the delivery is in transit to the user. For example, the remote computer system can receive updates (e.g., in real-time) regarding lost and/or stolen packages in different geographic areas. In response to receiving an update indicating an increase in stolen packages in a particular geographic area including an address corresponding to the delivery, the remote computer system can update the risk score to reflect the increase in stolen packages in this particular geographic area. The remote computer system can then notify the user of this increased risk score and/or notify the user of any changes to the verification settings for this delivery to the increased risk score. Similarly, the remote computer system can notify the user of the current verification settings (e.g., default settings, user settings) for this delivery and/or enable the user to update these verification settings before the delivery arrives.

Once a delivery person has arrived at or near the delivery location, the remote computer system can attempt to verify the delivery (i.e., the transaction) according to the set of verification settings specified for this delivery (e.g., based on the risk score and the user verification settings). In particular, for a low-security verification setting, the remote computer system can: notify the user (e.g., via text message) of the delivery (e.g., “Your delivery has arrived”) and automatically verify the delivery. For a moderate-security verification setting, the remote computer system can: notify the user of the delivery; prompt the user (e.g., via text message) to confirm receipt of delivery (e.g., “Swipe right to confirm receipt of the delivery or swipe left if you did not receive the delivery”); and, in response to receiving confirmation from the user, verify the delivery. For a high-security verification setting, the remote computer system can: notify the user of the delivery; prompt the user to confirm receipt of the delivery; and, in response to receiving confirmation of the delivery, prompt the user to provide a biometric (e.g., her thumbprint) via her mobile device. Then, in response to receiving the biometric from the user, the remote computer system can: access the user profile to match the biometric received to a confirmed biometric of the user stored in the user profile; and, in response to the biometric matching the confirmed biometric of the user, verify the delivery.

In each of these instances, the remote computer system can initiate a timer (e.g., a 30-second timer, a 1-minute timer) for verification of the delivery to be received. Then, in response to receiving verification of the delivery prior to expiration of the timer, the remote computer system can approve the delivery request and thereby enable completion of delivery (e.g., delivery or release of the medication to the user). Alternatively, in response to the expiration of the timer or receiving disconfirmation of the delivery by the user, the remote computer system can deny the delivery request and thereby stop the delivery before it is completed. Therefore, if the delivery is sent to the wrong user (e.g., a neighbor of the user), the remote computer system can stop this delivery before it is completed. In addition, the remote computer system can confirm immediately whether the user, or another user in the list of secondary users, received the delivery and therefore minimize losses due to missing deliveries or fraudulent attempts by users claiming deliveries were never received.

Finally, once the delivery request is approved, the remote computer system can generate a notification to send to the user (e.g., via mobile device) confirming approval and/or completion of the delivery. Alternatively, if the remote computer system determines a delivery to be fraudulent (e.g., attempted receival by a non-approved user) and/or denies a delivery request (e.g., due to lack of verification by the user), the remote computer system can similarly generate a notification to send to the user informing the user of the denied delivery.

### 9.2 Onboarding

As described above, the remote computer system can host or interface with a user portal (e.g., via native application or web application)—executing on the user's computing device (e.g., a mobile device, a computer)—to configure a user profile for the user. For example, the user may download the native application to her smartphone and create a new user profile. The user may manually populate the new user profile with various information, such as: name, contact information (e.g., phone number, email address, mailing address), social security number, financial information (e.g., credit card account(s), checking account(s), etc.).

In one example, a merchant may require the user to download the native application and create a new user profile to receive deliveries from this merchant. In particular, in this example, the user may initially visit the merchant (e.g., her pharmacy) in-person to verify her identity. The remote computer system can then generate a unique barcode associated with the user and store this unique barcode at the user profile for this user. The merchant may then give the user a printed copy of the unique barcode (e.g., generated by the remote computer system) such that the user may scan (e.g., via a camera on her mobile phone) the printed copy with her mobile phone, thus linking her mobile phone to the user and enabling verification of deliveries from this mobile phone. In addition, once the user has scanned this barcode and linked her mobile phone to her user account, the remote computer system can access the user's mobile phone to extract a set of biometrics (e.g., thumbprint, facial recognition data) stored in the user's mobile phone.

In one implementation, the remote computer system can host or interface with a merchant portal (e.g., via native application or web application)—executing on a computing device (e.g., a mobile device, a computer) of a merchant (e.g., a manager employed by the merchant)—to configure a merchant profile for the merchant. For example, the remote computer system can prompt the merchant to define a set of product types (e.g., apparel, grocery, medication, alcoholic beverages) offered by the merchant and a verification setting (e.g., verification required, default verification setting, verification not required) for each product type. The computer system can then leverage this information stored in the merchant profile when verifying delivery transaction requests.

### 9.2.1 User Household

The remote computer system can prompt the user to provide a list of users (or “secondary users”) eligible to accept and/or verify deliveries on behalf of the user. Once the user has input the list of secondary users, the remote computer system can prompt the user to provide contact information for each secondary user in the list of secondary users. For example, the remote computer system can prompt the user to generate a list of secondary users including each member of the user's household (e.g., spouse, children, roommates). The user may then populate a set of secondary user profiles, each secondary user profile associated with a member of her household and including contact information (e.g., phone number, email address) of each member. The remote computer system can then prompt (e.g., via text message) each member of the household provided by the user to generate their own user profile. (e.g., including contact information, age, biometric data, a passcode, other identifying information).

Further, the remote computer system can enable the user to specify a set of secondary user settings. For example, the remote computer system can receive a set of secondary user settings including: a minimum age requirement for verifying deliveries associated with a particular type of product; a subset of secondary users blocked from verifying deliveries associated with a particular merchant and/or type of merchant; a subset of secondary users blocked from verifying deliveries associated with risk scores above a threshold risk; and/or a particular merchant from which deliveries may be accepted by any secondary user and without verification (e.g., no biometrics required).

By enabling the user to generate a list of secondary users capable of receiving and/or verifying deliveries on behalf of the user, the remote computer system enables the user to assume responsibility (e.g., financial responsibility) for these deliveries in exchange for convenience (e.g., by not requiring the user to be available for receiving and verifying deliveries). Alternatively, the user may elect to designate no secondary users and thus require all deliveries be received and verified directly by the user. If a delivery is received by a different user, then a merchant or delivery company associated with the delivery may be financially liable for fraudulent (e.g., lost or stolen) deliveries, rather than the user.

### 9.2.2 User Verification Settings

Additionally, the user may elect to modify a set of default verification settings for authenticating deliveries to the user. For example, the remote computer system can define a first default verification setting specifying that only the user may verify and receive deliveries for transaction requests initiated by the user. The user, however, may replace the first default verification setting with a first user verification setting specifying her spouse may also verify and receive deliveries for transaction requests initiated by the user. In the foregoing example, the remote computer system can further define a second default verification setting specifying that transaction requests corresponding to risk scores above a threshold risk require a biometric (e.g., a thumbprint, a live image of her face) input by the user on her mobile device for verification. The user, however, may define a second user verification setting specifying that deliveries from a particular merchant do not require the biometric input by the user, regardless of risk scores associated with deliveries from the particular merchant.

Therefore, by enabling the user to adjust these verification settings, the remote computer system enables the user to assume responsibility for certain deliveries or delivery types in exchange for increased convenience. For example, if the user elects to require user verification only for delivery requests associated with transactions exceeding $50, the remote computer system can automatically approve delivery requests associated with transactions less than $50. However, in this example, if the remote computer system automatically approves a delivery request for $35 accepted by a fraudster or delivered to the wrong address, the user may ultimately be financially liable for the transaction. However, if the user maintains the default setting for user verification (e.g., always require user verification), a merchant or delivery service may be financially liable for a lost or stolen delivery, rather than the user.

### 9.3 Delivery Request

The remote computer system can receive delivery requests from merchants (e.g., from a mobile device of a delivery driver associated with the merchant) and extract delivery characteristics to evaluate risk of these delivery requests before approving deliveries. In particular, a user may initiate a delivery request (e.g., via online order, via mobile phone, in person) for a particular order (e.g., fast-food, groceries, medications) and with a particular merchant (e.g., restaurant, grocery store, pharmacy). The remote computer system can then receive the delivery request initiated by the user (e.g., via online order, via mobile phone, in person) and extract a set of delivery characteristics from the delivery request, such as: an identity of the user associated with the delivery request; a merchant and/or type of merchant with which the transaction request initiated; a URL and/or website at which the transaction initiated (e.g., if the transaction initiated online); and/or an amount (e.g., a dollar amount) of a financial transaction (e.g., value of the particular order) associated with the delivery request.

Upon receipt of the delivery request, the remote computer system can deliver a series of notifications to the user (e.g., via text message) that provide an update to the user on a status of the delivery. For example, the remote computer system can transmit a first text message to the user indicating the delivery request was received at a particular time. Later, the remote computer system can transmit a second text message to the user indicating the delivery is ready to be delivered to the user and including an estimated time of arrival of the delivery. Finally, the remote computer system can transmit a text message to the user indicating that the delivery has arrived. Therefore, by delivering notifications to the user throughout the delivery process, the remote computer system enables the user to be more prepared for the delivery and thus more likely to be available to verify the delivery upon arrival.

### 9.4 Risk Characterization

Upon receiving a delivery request including a set of delivery characteristics (e.g., user identity, merchant, type of product, amount of transaction associated with the delivery request), the remote computer system can characterize the risk (e.g., level of risk) associated with this delivery request based on the set of delivery characteristics.

For example, the remote computer system can characterize risk based on a type of product (e.g., groceries, restaurant orders, medications, clothing, household goods) associated with a delivery. In particular, in this example, the remote computer system can: characterize deliveries including grocery items, clothing, and/or other store-bought goods as low-risk; characterize deliveries including over-the-counter medications as moderate-risk; and characterize deliveries including prescription drugs, liquor, tobacco products, and/or weapons as high-risk. In another example, the remote computer system can characterize risk based on an amount (e.g., dollar amount) of a purchase (e.g., of a product) associated with the delivery. In particular, in this example, the remote computer system can: characterize deliveries associated with purchases less than $25 as low-risk; characterize deliveries associated with purchases exceeding $25 and less than $100 as moderate-risk; and characterize deliveries associated with purchases exceeding $100 as high-risk. In yet another example, the remote computer system can characterize risk based on both the type of product and the amount associated with the delivery. In particular, in this example, the remote computer system can: characterize deliveries including grocery items, clothing, and/or other store-bought goods associated with purchases less than $25 as low-risk; characterize deliveries including grocery items, clothing, and/or other store-bought goods associated with purchases exceeding $25 and falling below $100 as moderate-risk; characterize deliveries including over-the-counter medications associated with purchases falling below $100 as moderate-risk; characterize deliveries including prescription drugs, liquor, tobacco products, and/or weapons as high-risk; and characterize any delivery associated with a purchase above $100 as high-risk. Thus, the remote computer system can characterize risk of a delivery based on any delivery characteristic and/or any combination of delivery characteristics.

In one implementation, as described above, the remote computer system can access a risk model configured to intake the set of delivery (i.e. transaction) characteristics for the delivery and output a risk score. The remote computer system can access a generic risk model, a risk model defined by a particular merchant and/or third-party delivery service associated with the delivery, and/or a user specific risk model.

For example, a particular merchant (e.g., a convenience store) may specify a risk model defining: a first category of products (e.g., medications, alcoholic beverages) as “high-risk” requiring delivery confirmation and identification verification; a second category of products (e.g., high-value products) as “moderate-risk” and assigned delivery confirmation; and a third category of products (e.g., low-value products) as “low-risk” and assigned delivery notification. The remote computer system can then store this risk model at a merchant profile, in a set of merchant profiles, associated with this particular merchant. Then, in response to receiving a transaction request for a grocery delivery including alcoholic beverages from this merchant, the remote computer system can: access the risk model stored in the merchant profile for this merchant; and characterize risk for this transaction as “high-risk” according to the risk model.

Further, in this example, the remote computer system can access a user profile of a user associated with this delivery request. If the user profile specifies a threshold transaction value (e.g., minimum dollar value) for delivery verification (e.g., for receiving delivery notifications) greater than a value (e.g., dollar value) associated with this grocery delivery, the remote computer system can prioritize the “high-risk” characterization of the merchant risk-model and require both delivery confirmation and identification verification. However, in this example, if instead the delivery request only includes groceries without alcoholic beverages, the remote computer system can characterize the grocery delivery as “moderate-risk” (e.g., assigned to delivery confirmation). Then, the remote computer system can prioritize the threshold transaction value specified by the user to select an appropriate verification method.

Therefore, the remote computer system can combine preferences from both a merchant, a user, and/or a delivery service (e.g., third-party delivery service) to characterize risk and/or select a verification method for a particular delivery request.

### 9.5 Delivery Verification

Once the delivery has arrived (e.g., at the user's home), the remote computer system can access the user profile of the user to extract the set of verification settings corresponding to the risk associated with the delivery. For example, in response to the risk score exceeding a threshold risk score, the remote computer system can prompt the user (e.g., via text message) to verify the transaction. The remote computer system can generate a verification request including a summary of the delivery (e.g., merchant, amount, product(s), time) and a prompt that reads: “Did you receive this delivery? If yes, swipe right. If no, swipe left.” The verification request can include a responsive element configured to receive a “swipe right” or “swipe left” input from the user. Therefore, the user may swipe right on the responsive element to indicate that she received the delivery and thus verify validity of the delivery or swipe left to indicate that she did not receive the delivery.

Further, the remote computer system can request an identifier (e.g., biometric, passcode, response to a user-specific question) to confirm the identity of the user and thus verify the delivery. Upon receipt of this identifier from the user, the remote computer system can compare data of this identifier to data previously obtained from the user and stored in the user's profile to confirm the users identify. The remote computer system can implement different types or combinations of user verification corresponding to different levels of security based on the risk of this delivery.

The remote computer system can initiate a timer upon sending the verification request to the user, such that the user must confirm the delivery within a set duration (e.g., 30 seconds, 1 minute, 3 minutes). For example, the remote computer system can: send a verification request to the user prompting the user to confirm receipt of the delivery; and approximately concurrently initiate a timer for two minutes. Then, the remote computer system can: prompt the user to provide a thumbprint (e.g., via her mobile phone) to verify her identity; and approximately concurrently initiate a timer for 30 seconds. In response to receiving both confirmation of receipt and the thumbprint verification from the user before expiration of each timer, the remote computer system can verify the delivery. However, in response to expiration of either timer before receiving confirmation from the user, the remote computer system can deny the delivery request. Alternatively, in response to expiration of the timer(s) before receiving confirmation from the user, the remote computer system can: access the user profile to extract the list of secondary users; select a first secondary user from the list of secondary users; and transmit a verification request to the first secondary user. Therefore, the remote computer system can attempt to verify the delivery with another user in the user's household before denying the delivery request.

### 9.6 Finalize Delivery

Once verification of the delivery has been received from the user, the remote computer system can approve the delivery request. Alternatively, if verification of the delivery is not received, the remote computer system can deny the delivery request. The remote computer system can transmit the denied delivery request to the courier (e.g., associated with the merchant) and to the merchant.

In one variation, the remote computer system can host or interface with a courier portal (e.g., via native application or web application)—executing on a computing device (e.g., a mobile device, a computer) of a courier associated with the delivery request to complete delivery verification. For example, the remote computer system can receive confirmation of initiation of a delivery period (e.g., when the courier arrives at an address of the user) from a mobile device of a courier associated with the first delivery request via an instance of a courier portal executing on the mobile device. In response to receiving this confirmation, the remote computer system can generate and transmit a verification request to a mobile device of the user via push notification (e.g., from a native application executing on the user's mobile device). The user may then confirm the verification request via an instance of the user portal (e.g., within the native application) executing on her mobile device. Then, in response to receiving confirmation of the verification request via the instance of the user portal, the remote computer system can: approve the first delivery request; generate an approval notification indicating approval of the first delivery request; and transmit this approval notification to the mobile device associated with the courier via the instance of the courier portal. Upon receiving this approval notification via the instance of the courier portal, the courier may then complete the delivery (e.g., transfer delivery to the user, leave the delivery on the user's doorstep). Additionally and/or alternatively, the courier can then confirm completion of the delivery via the instance of the courier portal.

Once the delivery is approved, the remote computer system can generate a notification to send to the user (e.g., via mobile device) confirming approval and/or completion of the delivery. Alternatively, if the remote computer system determines a delivery to be fraudulent and/or denies a delivery request, the remote computer system can similarly generate a notification to send to the user informing the user of the denied delivery.

### 10. Method: Charging Station Verification

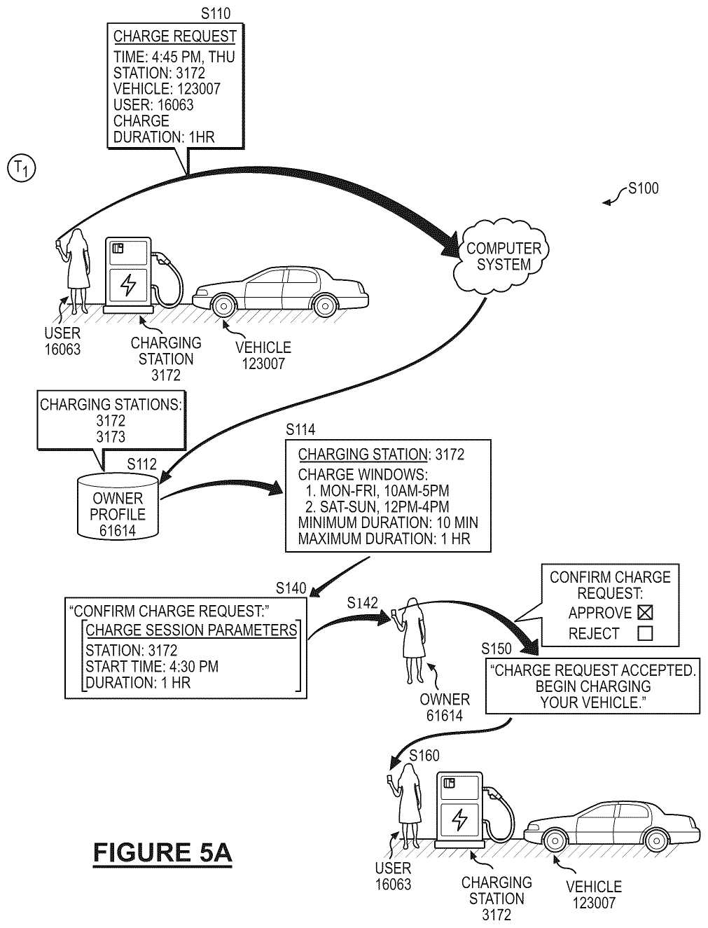

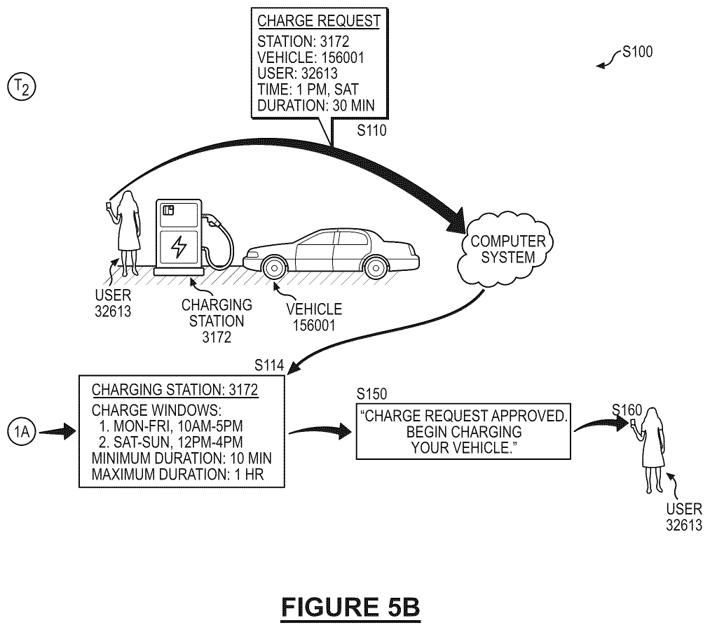

In one variation, as shown in FIGS. 5A and 5B, the method S100 includes, during a first time period, receiving a first charge request for a first charge session from a first mobile device accessed by a first user in Block S110, the first charge request defining a first set of request characteristics including: a first station identifier associated with a first charging station; a first vehicle identifier associated with a first electric vehicle affiliated with the first user; and a first set of charge parameters including a first charge window. The method S100 further includes, in response to receiving the first charge request: accessing a first owner profile, in a set of owner profiles, associated with an owner of the first charging station based on the first station identifier in Block S112; extracting a set of target charge parameters defined by the first owner from the first owner profile in Block S114; and characterizing a first difference between the first set of charge parameters and the set of target charge parameters. The method S100 further includes, in response to the first difference exceeding a threshold difference: generating a first verification request comprising a first prompt to review the first charge request for the first charge session in Block S140; transmitting the first verification request to a second mobile device affiliated with the owner in Block S142; and, in response to receiving authorization of the first charge session from the owner at the second mobile device, approving the first charge request in Block S150.

In the preceding variation, the method S100 further includes, during a second time period, receiving a second charge request for a second charge session from a third mobile device accessed by a second user in Block S110, the second request defining a second set of request characteristics including: the first station identifier associated with the first charging station; a second vehicle identifier associated with a second electric vehicle affiliated with the second user; and a second set of charge parameters including a second charge window. The method S100 further includes, in response to receiving the second charge request: accessing the first owner profile associated with the owner of the first charging station based on the first station identifier in Block S112; extracting the set of target charge parameters defined by the first owner in Block S114; characterizing a second difference between the first set of charge parameters and the set of target charge parameters; and, in response to the second difference falling below the threshold difference, approving the second charge request in Block S150.

In one variation, the method S100 further includes, in response to receiving rejection of the first charge session from the owner at the second mobile device, denying the first charge request.

In one variation, the method S100 includes, during a first time period, receiving a first charge request for a first charge session from a first mobile device accessed by a first user in Block S110, the first charge request defining a first set of request characteristics including: a first station identifier associated with a first charging station; a first vehicle identifier associated with a first electric vehicle affiliated with the first user; and a first set of charge parameters comprising a first charge amount. The method S100 further includes, in response to receiving the first charge request: accessing a first owner profile, in a set of owner profiles, associated with an owner of the first charging station based on the first station identifier in Block S112; and extracting a set of target charge parameters defined by the first owner from the first owner profile in Block S114, the set of target charge parameters comprising a threshold charge amount. The method S100 further includes, in response to the first charge amount falling below the threshold charge amount: generating a first verification request comprising a first prompt to review the first charge request for the first charge session in Block S140; transmitting the first verification request to a second mobile device affiliated with the owner in Block S142; and, in response to receiving authorization of the first charge session from the owner at the second mobile device, approving the first charge request in Block S150.

In the preceding variation, the method S100 further includes, during a second time period: receiving a second charge request for a second charge session from a third mobile device accessed by a second user in Block S110, the second request defining a second set of request characteristics including the first station identifier, a second vehicle identifier associated with a second electric vehicle affiliated with the second user, and a second set of charge parameters including a second charge amount; and, in response to receiving the second charge request and in response to the second charge amount falling below the threshold amount, approving the second charge request in Block S150.

### 10. Charging Station Verification

In one variation, as shown in FIG. 5, the remote computer system can verify an identity of a user in order to approve a charge transaction—corresponding to a particular charge session—between a user affiliated with an electric vehicle and an owner of an electric vehicle charging station (hereinafter a “charging station”).

In this variation, the remote computer system can receive a vehicle charge request (hereinafter a “charge request”) for a charge session—corresponding to charging of an electric vehicle affiliated with (e.g., owned by) a user—at a charging station affiliated with (e.g., owned by) a particular owner. In particular, the remote computer system can receive this charge request and extract a set of request characteristics defined by the charge request, such as including: an identity of the user; an identity of the owner of the charging station; identifying information for the electric vehicle; identifying information for the charging station; a start time-such as defining a time of day, a day of the week, and/or a particular calendar date—of the charge session; a duration of the charge session; a charge value-such as a battery percentage (e.g., 10%, 50%, 100%), an energy amount (e.g., 5 kWh, 20 kWh, 40 kWh), and/or a transaction amount-defined for the charge session; etc. Based on these request characteristics, the remote computer system can then selectively: automatically approve the charge request for the charge session; automatically reject the charge request for the charge session; and/or prompt the owner of the charging station to manually approve and/or reject the charge request for this charge session.

The remote computer system can enable the owner to manage charge request verification and notification settings, such as based on a time window-defining a start time and a duration of charging—and/or a charge value (e.g., a battery amount, a transaction amount) corresponding to the charge session.

By enabling the owner to adjust these settings, the remote computer system can enable the owner to assume greater responsibility for these deliveries in exchange for increased user convenience and control of receiving deliveries—and vice versa.

Further, the remote computer system can streamline operation for merchants and/or third-party delivery services and reduce rate of failed delivery attempts by: ensuring that designated users receive their deliveries; verifying receipt of deliveries with users in real-time; preventing lost or stolen deliveries; and/or reducing liability of merchants and/or third-party delivery services for lost or stolen deliveries when users opt out of greater security settings in exchange for greater delivery flexibility.

### 10.1 Onboarding

In one implementation, the remote computer system can host or interface with an owner portal (e.g., via native application or web application)—executing on the owner's computing device (e.g., a mobile phone, a tablet, a desktop computer)—to configure an owner profile for the owner of a charging station. For example, the remote computer system can prompt the owner to provide: a station identifier (e.g., a barcode, a pin number) affiliated with the charging station; a geographic location of the charging station; a vehicle type(s) of vehicles supported for charging by the charging station; a set of verification settings (e.g., verification required, verification not required, a default verification setting) for verifying charge requests received for the charging station; a set of target charge parameters, such as including predefined charge windows available for vehicle charging and/or minimum or maximum charge values for charge sessions; etc. The computer system can then leverage this information stored in the owner profile to verify and/or reject charge requests specifying this particular charging station.

Additionally or alternatively, in this implementation, the remote computer system can host or interface with a user portal (e.g., via native application or web application)—executing on the user's computing device (e.g., a mobile phone, a tablet, a desktop computer)—to configure a user profile for the user (e.g., an electric vehicle owner and/or operator). For example, the user may download the native application to her smartphone and create a new user profile. The user may manually populate the new user profile with various information, such as including: name, contact information (e.g., phone number, email address, mailing address), financial information (e.g., credit card information, checking account information), vehicle information (e.g., a vehicle identifier, license plate data, a vehicle make and/or model), etc.

In one example, an owner of a charging station may require a user to download the native application and create a user profile to request to charge a vehicle affiliated with (e.g., owned and/or operated by) the user at the charging station.

### 10.1.1 Target Charge Parameters

In one implementation, the remote computer system can prompt the owner to select a set of target charge parameters for charge sessions initiated at the charging station affiliated with the owner. The remote computer system can then store this set of target charge parameters in the owner profile generated for the owner.

In particular, in this implementation, the remote computer system can prompt the owner to provide a set of target charge parameters, such as: a set of charge windows—each charge window defining a start time (e.g., a time of day) and a duration (e.g., 30 minutes, 1 hour, 8 hours, 24 hours)—during which the charging station is available for charge sessions; a set of blocked windows during which the charging station is unavailable; a minimum value (e.g., a minimum charge amount and/or a minimum transaction amount) associated with a charge session; a maximum value (e.g., a maximum charge amount and/or a maximum transaction amount) associated with a charge session; a minimum or maximum duration for a charge session; etc. The remote computer system can thus: receive the set of target charge parameters defined by the owner; store the set of target charge parameters in the owner profile; and later—in response to receiving a charge request for a charge session at the charging station affiliated with this owner-leverage the set of target charge parameters stored in the owner profile to selectively approve, reject, and/or request owner authorization of the charge request.

### 10.1.2 Owner Verification Settings

In one implementation, the remote computer system can prompt the owner to select a set of owner verification settings for verifying charge requests for charge sessions at a charging station affiliated with the owner.

For example, the remote computer system can define a first default verification setting specifying that any charge request defining a charge parameter (e.g., a duration, a start time, a charge value), in a set of charge parameters, differing from a corresponding target charge parameter (e.g., a target duration, a target start time, a target charge value), in the set of target charge parameters (e.g., defined by the owner), requires verification of the charge request by the owner. The owner, however, may replace the first default verification setting to enable automatic verification—by the remote computer system—of a charge request defining a charge parameter differing from a corresponding target charge parameter in response to a difference between the target charge parameter and the charge parameter falling within a threshold difference.

In particular, in one example, the owner may define a first target charge parameter of a target charge window between 8 AM and 4 PM every weekday.

Furthermore, the owner may define a first verification setting specifying: owner verification of charge requests for charge sessions falling outside of the target charge window and defining a transaction value less than a threshold value; automatic verification (e.g., by the remote computer system) of charge requests for charge sessions overlapping the target charge window, defining a start time within a threshold duration (e.g., 5 minutes, 10 minutes, 1 hour) of 8 AM on a weekday, and defining a transaction value exceeding a threshold transaction value; and automatic verification (e.g., by the remote computer system) of charge requests for charge sessions overlapping the target charge window, defining an end time within a threshold duration (e.g., 5 minutes, 10 minutes, 1 hour) of 4 PM on a weekday, and defining a transaction value exceeding the threshold transaction value.

### 10.2 Charge Request

The remote computer system can receive a charge request from a user (e.g., from a mobile device of an electric vehicle owner and/or operator) and extract a set of charge characteristics—defined for a charge session associated with the charge request—to evaluate the charge request for the charge session and therefore selectively approve and/or reject the charge request.

In particular, the computer system can receive a charge request initiated by a first user—such as via the user's mobile device and/or at a particular charging station—and extract a set of charge characteristics from the charge request, such as: a particular charging station at which the first user is requesting to charge her electric vehicle; a particular electric vehicle affiliated with the first user (e.g., owned and/or operated by the first user) and associated with the charge request; an identity of the owner affiliated with the first charging station; an identity of the first user affiliated with the particular electric vehicle; a charge window-defining a start time and/or a duration—for the charge session; a charge amount representative of an amount of power supplied to a battery of the electric vehicle; a transaction value representative of a value assigned to the charge amount; a geographic location of the particular charging station; a geographic location of the first user and/or the first user's mobile device; financial information (e.g., a credit card number, an online money transfer account) for the first user; etc.

In one implementation, in response to receiving a charge request—for a charge session at a charging station—from a first user (e.g., electric vehicle owner and/or operator), the remote computer system can identify an owner of the charging station. In particular, in this implementation, the remote computer system can: receive a charge request—for a charge session from a first user (e.g., from a mobile device accessed by the first user)—defining a set of request characteristics including a station identifier (e.g., a pin number, a code, a set of location coordinates) associated with the charging station; and—based on the station identifier (e.g., linked and/or stored in the owner profile)—access an owner profile, in a set of owner profiles, associated with an owner of the charging station. The remote computer system can then leverage information stored in the owner profile-such as including a set of target charge parameters, a set of verification settings, and/or owner contact information—to selectively authorize, reject, and/or request authorization of the charge request.

### 10.2.1 Charge Request: Backend

Generally, the remote computer system can receive a charge request-initiated by a user (e.g., an owner and/or operator of an electric vehicle)—for a charge session specifying a particular charging station and a particular electric vehicle. For example, the remote computer system can receive a charge request initiated by a first user and defining a first set of transaction characteristics including: a first vehicle identifier associated with a first electric vehicle affiliated with the first user; and a first station identifier associated with a first charging station affiliated with a first owner. The remote computer system can therefore identify the charging station, the electric vehicle, the first owner, and/or the first user based on the first set of transaction characteristics.

In one implementation, the remote computer system can receive a charge request from the mobile device accessed by the user. In particular, in this implementation, the user may initiate a charge request by selecting the charging station—for a charge session at this charging station-within an instance of the user portal (e.g., a native application) executing on the user's mobile device. The remote computer system can then receive this selection from the user's mobile device charge request-paired with the the station identifier associated with the charging station and the vehicle identifier associated with an electric vehicle affiliated with the user-directly from the user's mobile device (e.g., via the instance of the user portal).

The remote computer system can then execute Blocks of the method S100 to selectively approve or reject the charge request. In this implementation, in response to approving the charge request, the remote computer system can: trigger the charging station to enable charging of the first electric vehicle; and access payment information-stored in the user's profile—to initiate a payment from the user to the owner for the charge session. For example, in response to approving the charge request, the remote computer system can: generate a charge session packet including the vehicle identifier and a set of charge parameters—such as a start time and a duration-defined for the charge session

Additionally or alternatively, in another implementation, the remote computer system can receive a charge request from the charging station affiliated with the owner. In particular, in this implementation, the remote computer system can receive a charge request for a charge session from a first charging station affiliated with a first owner and accessed by a first user, the charge request defining a set of request characteristics including a station identifier associated with the charging station and a first vehicle identifier associated with an electric vehicle affiliated with the first user. Based on the first vehicle identifier, the remote computer system can: access a user profile, in a set of user profiles, associated with the first user based on the first vehicle identifier contained in the user profile; and extract a set of user information-including contact information, payment information, etc-defined for the first user in the first user profile accordingly.

For example, the charging station can be configured to receive a vehicle identifier of an electric vehicle at the charging station (e.g., parked proximal and/or adjacent the charging station). In one example, the user may manually enter the vehicle identifier (e.g., a code) on a display of the charging station. Alternatively, in another example, the charging station can include an optical sensor configured to capture the vehicle identifier (e.g., a barcode, a QR code) arranged on the electric vehicle and/or rendered on the user's mobile device (e.g., within an instance of the user portal). Alternatively, in yet another example, the charging station can include a transceiver configured to retrieve a vehicle identifier of an electric vehicle detected proximal the transceiver for transmitting to the remote computer system. In each of these examples, the remote computer system can receive a charge request specifying the vehicle identifier and/or additional request characteristics (e.g., a station identifier, a set of charge parameters) from the charging station.

### 10.3 Charge Request Verification

In response to receiving a charge request—for a charge session at a particular charging station-including a set of request characteristics (e.g., electric vehicle, charging station, user, owner, charge window, start time, duration, charge amount, transaction value), the remote computer system can selectively approve and/or reject the charge request based on these request characteristics and a set of target charge parameters defined for the particular charging station (e.g., by the owner).

In particular, the remote computer system can receive a charge request for a charge session at a charging station, initiated by a user, and defining a set of request characteristics including a station identifier-associated with the charging station and/or owner of the charging station- and a set of charge parameters (e.g., a charge window, a start time of the charge window, a duration of the charge window, a charge amount, a transaction value); and—based on the station identifier-access a set of target charge parameters (e.g., default settings, owner-specific settings) defined for the charging station. Then, based on the set of target charge parameters and the set of charge parameters, the remote computer system can: automatically approve the charge request and trigger the charging station to enable charging of an electric vehicle affiliated with the user; automatically reject the charge request and withhold triggering of the charging station to enable charging of the electric vehicle; or transmit a verification request—requesting authorization of the charge request—to the owner of the charging station (e.g., at the owner's mobile device).

In one implementation, the remote computer system can: characterize a difference between the set of charge parameters (e.g., a charge window, a duration of the charge window, a start time of the charge window, a charge amount, a transaction value) defined for a charge session (e.g., by the user) and the set of target parameters defined for the charging station (e.g., by the station owner) in the corresponding owner profile; and, based on the difference, selectively approve the charge request, reject the charge request, and/or request owner authorization of the charge request. For example, in response to the difference falling below a threshold difference, the remote computer system can automatically approve the charge request. Alternatively, in response to the difference exceeding the threshold difference, the remote computer system can: generate a verification request including a prompt to review the charge request-including the set of charge parameters—for the charge session; and, in response to receiving authorization of the charge session from the owner (e.g., via the owner's mobile device), approve the charge request. Alternatively, in response to receiving rejection of the charge session from the owner, the remote computer system can reject the charge request and notify the user accordingly.

### 10.3.1 Request Approved

In response to the set of charge parameters corresponding to the set of target parameters, the remote computer system can approve the charge request for the charge session at the charging station. In particular, in on implementation, the remote computer system can: generate a notification indicating approval of the charge request; transmit the notification to the user (e.g., initiating the charge request); and trigger the charging station to enable charging of the electric vehicle-according to the set of charge parameters-affiliated with the user. For example, the remote computer system can transmit a notification indicating approval of the charge request to the user's mobile device and/or trigger the charge station to render the notification on a display of the charging station for viewing by the user. The user may then couple (e.g., electrically couple) a battery of the electric vehicle to the charging station for charging during the charge session.

In one variation, in response to approving the charge request, the remote computer system can initiate a financial transaction-according to the set of charge parameters—for the charge session. In this variation, the owner of the charging station may link and/or include financial account information (e.g., a bank account, a virtual wallet) to her owner profile and the remote computer system can automatically distribute a portion (e.g., a predefined portion, a dynamic portion) of a transaction value associated with the charging station from the user's payment to the owner's account, such as prior to initiation of the charge session and/or upon conclusion of the charge session.

For example, the user may swipe her credit card at the charging station to initiate the charge request and therefore authorize payment for the charge session. In this example, in response to approving the charge request, the remote computer system can automatically allocate a portion of payment for the charge session for distributing to the owner according to financial account information specified in the owner profile. Alternatively, the user may enter her financial account information (e.g., bank account, virtual wallet) in a user profile generated for the user (as described above). In this example, in response to approving the charge request, the remote computer system can: trigger the charge station to enable charging of the electric vehicle according to the set of charge parameters; access a transaction value defined for the charge session; accessing a user profile, in a set of user profiles, associated with the first user based on the first vehicle identifier; extract a first wallet identifier, from the user profile, corresponding to a first financial account associated with the user; extract a second wallet identifier, from the owner profile, corresponding to a second financial account associated with the owner; and allocate a portion of the transaction value for distribution from the user and to the owner based on the first wallet identifier and the second wallet identifier.

### 10.3.2 Owner Verification Required

Alternatively, based on a difference between the set of charge parameters defined for the charge session and the set of target charge parameters defined for the charging station, the remote computer system can require owner verification of the charge request. In particular, in one implementation, the remote computer system can: generate a verification request including a prompt to review the charge request for the charge session; and transmit the verification request to the owner (e.g., at the owner's mobile device) for review. Then, in response to receiving authorization of the charge session from the owner (e.g., via the owner's mobile device)—such as within an instance of the owner portal executing on the owner's mobile device—the remote computer system can approve the charge request and trigger the charging station to enable charging of the user's electric vehicle accordingly. Alternatively, in response to the owner withholding authorization of the charge session from the owner, the remote computer system can reject the charge request accordingly and/or notify the user of rejection of the charge request.

In one variation, the remote computer system can initiate a timer for receiving authorization of the charge session from the owner. In particular, in this variation, the remote computer system can: transmit a verification request to the owner (e.g., at the owner's mobile device) including a prompt to authorize the charge session and/or including the set of charge parameters defined by the charge request; and, in response to transmitting the verification request to the owner, initiate a timer for a set duration (e.g., 1 minute, 5 minutes, 15 minutes) for receiving authorization. Then, in response to receiving authorization of the charge session prior to expiration of the timer, the remote computer system can approve the charge request. Alternatively, in response to expiration of the timer prior to receiving authorization of the charge request, the remote computer system can reject the charge request. Furthermore, in response to the owner disapproving the charge session prior to expiration of the timer, the remote computer system can reject the charge request.

### 10.3.3 Modified Charge Parameters

In one variation, the remote computer system can suggest a set of modified charge parameters for a charge session based on the set of target charge parameters—defined by the station owner—and the set of charge parameters specified in the charge request. In particular, in this variation, the remote computer system can: receive a charge request for a charge session at the charging station and defining a set of charge parameters; access a set of target charge parameters defined for charging sessions at this charging station; characterize a difference between the set of charge parameters and the set of target charge parameters; and, based on the difference, derive a set of modified charge parameters-corresponding to the set of target charge parameters—for the charge session; and return the set of target charge parameters to the user for review.

For example, the remote computer system can: receive a request from a user (e.g., from the user's mobile device)—for a charge session at a charging station affiliated with an owner-defining a first set of charge parameters including a start time of 10 AM and a first charge amount of 25 percent; access a set of target charge parameters—including a daily charging window of 9 AM to 4 PM and a minimum charge amount of 50 percent. Then, in response to the start time-specified in the request—falling within the daily charging window and the first charge amount falling below the minimum charge amount, the computer system can: derive a second set of charge parameters—for the charge session specified in the request-including the start time of 10 AM and a second charge amount of 50 percent; generate a verification request including the second set of charge parameters and a prompt to approve and/or reject the second set of charge parameters; and transmit the notification to the user for review.

Additionally or alternatively, in the preceding example, in response to the start time-specified in the request—falling within the daily charging window and the first charge amount falling below the minimum charge amount, the computer system can request owner verification of the charge request, as described above. Then, in response to the owner rejecting the charge request-specifying the first set of charge parameters—the computer system can suggest the second set of charge parameters to the user in replacement of the first set of charge parameters.

### 10.4 Variation: Scheduled Charge Session

In one variation, the remote computer system can schedule a charge session in advance of a charge window defined for the charge session. In particular, the remote computer system can approve a charge request for a charge request defining a set of request characteristics including: a vehicle identifier associated with an electric vehicle owned by a user; a station identifier associated with a charging station affiliated with an owner of the charging station; and a set of charge parameters including a charge window—defining a particular start time and/or a particular duration—and/or a charge amount. The remote computer system can then schedule the charge session according to the set of charge parameters accordingly.

In particular, in one implementation, at a first time, in response to approving the charge request, the remote computer system can: generate a charge session packet including the station identifier, the vehicle identifier, and the set of charge parameters; and store the charge session packet in a scheduling database including a corpus of charge session packets corresponding to scheduled charge sessions. Then, at a second time succeeding the first time, in response to receiving a request-specifying the vehicle identifier—from the charging station, the remote computer system can: retrieve the charge session packet based on the vehicle identifier; extract the charge window defined by the charge session packet; and, in response to the second time falling within a threshold duration of the particular start time defined for the charge window, trigger the charging station to enable charging of the electric vehicle according to the set of charge parameters. Therefore, in this example, the remote computer system can automatically enable charging of an electric vehicle detected at the charging station-such as via scanning of the vehicle identifier-during a charge window specified in a pre-scheduled charge session.

### 10.5 Variation: Demand

In one variation, the remote computer system can leverage current demand for power (e.g., electricity)—from a power source electrically coupled to the charging station and configured to supply power to the charging station for transfer to a battery of an electric vehicle coupled to the charging station—to selectively approve, reject, and/or verify approval (e.g., with the owner) of a charge request at the charging station.

In particular, in one implementation, the remote computer system can: receive a charge request defining a set of request characteristics including a station identifier-associated with a first charging station—and a set of charge parameters including a first charge window and/or a first charge amount (e.g., an amount of electricity supplied, an amount of a battery charged); access an owner profile affiliated with the first charging station based on the station identifier; extract a set of target charge parameters-including a threshold charge value-defined for charge sessions at the first charging station; select a first demand factor, in a set of demand factors, based on demand for power from a power supply, electrically coupled to the first charging station, during the first charge window; derive a first charge value for the first charge session based on the first demand factor and the set of charge parameters including the first charge amount and/or the first charge window; characterize a difference between the first charge value and the threshold charge value; and selectively approve, reject, and/or verify approval of the charge request based on the difference.

For example, the remote computer system can: automatically approve the charge request in response to the first charge value falling below the threshold charge value; generate a verification request-prompting the owner to authorize or reject the charge request—and transmit the verification request to the owner for review in response to the first charge value exceeding the threshold charge value and falling within a threshold deviation of the threshold charge value; and/or automatically reject the verification request in response to the first charge value exceeding and falling outside the threshold deviation of the threshold charge value. Additionally or alternatively, in another example, the remote computer system can: automatically approve the charge request in response to the first charge value falling below the threshold charge value; and generate a verification request—prompting the owner to authorize or reject the charge request—and transmit the verification request to the owner for review in response to the first charge value exceeding the threshold charge value.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
receiving a first charge request for a first charge session from a first mobile device accessed by a first user, the first charge request defining a first set of request characteristics comprising:
a first station identifier associated with a first charging station;
a first vehicle identifier associated with a first electric vehicle affiliated with the first user; and
a first set of charge parameters comprising a first charge window; and
in response to receiving the first charge request:
accessing a first owner profile, in a set of owner profiles, associated with an owner of the first charging station based on the first station identifier;
extracting a set of target charge parameters defined by the first owner from the first owner profile;
characterizing a first difference between the first set of charge parameters and the set of target charge parameters; and
in response to the first difference exceeding a threshold difference:
generating a first verification request comprising a first prompt to review the first charge request for the first charge session;
transmitting the first verification request to a second mobile device affiliated with the owner; and
in response to receiving authorization of the first charge session from the owner at the second mobile device, approving the first charge request; and
during a second time period:
receiving a second charge request for a second charge session from a third mobile device accessed by a second user, the second request defining a second set of request characteristics comprising:
the first station identifier associated with the first charging station;
a second vehicle identifier associated with a second electric vehicle affiliated with the second user; and
a second set of charge parameters comprising a second charge window; and
in response to receiving the second charge request:
accessing the first owner profile associated with the owner of the first charging station based on the first station identifier;
extracting the set of target charge parameters defined by the first owner;
characterizing a second difference between the first set of charge parameters and the set of target charge parameters; and
in response to the second difference falling below the threshold difference, approving the second charge request.

2. The method of claim 1, further comprising, in response to receiving rejection of the first charge session from the owner at the second mobile device, denying the first charge request.

3. The method of claim 1, further comprising, during a third time period:
receiving a third charge request for a third charge session from a third mobile device accessed by a third user, the third charge request defining a third set of request characteristics comprising:
a third vehicle identifier associated with a third electric vehicle affiliated with the third user;
a second station identifier associated with a second charging station; and
a third set of charge parameters comprising a third charge window; and
in response to receiving the third charge request:
accessing a second owner profile, in a set of owner profiles, associated with a second owner of the second charging station, based on the second station identifier;
extracting a second set of target charge parameters, defined by the second owner, from the second owner profile;
characterizing a third difference between the third set of charge parameters and the second set of target charge parameters; and
in response to the third difference exceeding the threshold difference:
generating a second verification request comprising a second prompt to review the third charge request for the third charge session;
transmitting the second verification request to a fourth mobile device affiliated with the second owner; and
in response to receiving authorization of the third charge session from the owner at the second mobile device, approving the third charge request.

4. The method of claim 1:
wherein receiving the first request from the first mobile device comprises receiving the first request from a first instance of a user portal executing on the first mobile device;
wherein transmitting the first verification request to the second mobile device affiliated with the owner comprises transmitting the first verification request to a first instance of an owner portal executing on the second mobile device; and
wherein receiving the second charge request from the third mobile device comprises receiving the second charge request from a second instance of the user portal executing on the third mobile device.

5. The method of claim 1:
wherein extracting the set of target charge parameters from the first owner profile comprises extracting the set of target charge parameters and a first set of contact information, corresponding to the owner, from the first owner profile; and
wherein transmitting the first verification request to the second mobile device affiliated with the owner comprises transmitting the first verification request to the second mobile device affiliated with the owner via the first set of contact information.

6. The method of claim 1:
wherein receiving the first charge request defining the first set of request characteristics comprising the first set of charge parameters comprising the first charge window comprises receiving the first charge request defining the first set of request characteristics comprising the first set of charge parameters comprising the first charge window and a first charge amount supplied to the first electric vehicle;
wherein extracting the set of target charge parameters comprises extracting the set of target charge parameters comprising a threshold charge value defined for charge sessions at the first charging station; and
wherein characterizing the first difference between the first set of charge parameters and the first set of target charge parameters comprises:
selecting a first demand factor, in a set of demand factors, based on demand for a power supply during the first charge window, the power supply electrically coupled to the first charging station and configured to supply power to the first charging station for supply of electricity to a battery of an electric vehicle electrically coupled to the first charging station;
based on the first demand factor and the first charge amount, deriving a first charge value for the first charge session; and
characterizing the first difference between the first charge value and the threshold charge value.

7. The method of claim 1:
wherein generating the first verification request in response to the first difference exceeding the threshold difference comprises generating the first verification request in response to the first difference exceeding the threshold difference and falling below a second threshold difference; and
further comprising, in response to the first difference exceeding the second threshold difference, automatically rejecting the first charge request.

8. The method of claim 1:
further comprising:
at an initial time, receiving a query for a charging station within a threshold distance of the first mobile device; and
in response to receiving the query:
isolating a first subset of charging stations, in a set of charging stations, located within the threshold distance of the first mobile device, the first subset of charging stations comprising the first charging station; and
presenting the first subset of charging stations to the first user at the first mobile device; and
wherein receiving the first charge request for the first charge session comprises, in response to selection of the first charging station, in the first subset of charging stations, by the first user at the first mobile device, receiving the first charge request for the first charge session at a first time succeeding the initial time.

9. The method of claim 1:
wherein receiving the first charge request defining the first set of request characteristics comprising the first set of charge parameters comprising the first charge window comprises receiving the first charge request defining the first set of request characteristics comprising the first set of charge parameters comprising the first charge window defining a first start time and a first duration;
wherein extracting the set of target charge parameters comprises extracting the set of target charge parameters comprising a set of target charge windows, each target charge window, in the set of target charge windows, defining a target start time and a target duration; and
wherein characterizing the first difference between the first set of charge parameters and the set of target charge parameters comprises:
for each target charge window, in the set of target charge windows, deriving a difference, in a first set of differences, between the target charge window and the first charge window based on the target start time and the target duration defined by the target charge window and the first start time and the first duration defined by the first charge window; and
characterizing the first difference based on the first set of differences.

10. The method of claim 1, further comprising, in response to receiving rejection of the first charge session from the owner at the second mobile device:
deriving a third set of charge parameters for the first charge session based on the first difference between the first set of charge parameters and the set of target charge parameters;
generating a second verification request comprising a second prompt to review the third set of charge parameters for the first charge session; and
in response to receiving authorization of the third set of charge parameters from the first user, approving the first charge request.

11. The method of claim 1, wherein approving the first charge request comprises:
generating a second notification indicating approval of the first charge request;
transmitting the second notification to the first user at the first mobile device; and
triggering the first charge station to enable charging of a vehicle affiliated with the first user according to the first set of charge parameters.

12. The method of claim 1:
wherein receiving the first charge request from the first mobile device comprises in response to a first scan event, initiated by the first user at the first mobile device, that captures the first station identifier displayed on the first charging station, receiving the first charge request from the first mobile device at a first time; and
wherein transmitting the first verification request to the second mobile device comprises transmitting the first verification request to the second mobile device at a second time succeeding the first time and falling within a threshold duration of the first time.

13. The method of claim 12, wherein approving the first charge request in response to receiving authorization of the first charge session from the owner further comprises:
in response to transmitting the first verification request to the second mobile device, initiating a timer for a fixed duration;
in response to receiving authorization of the first charge session from the owner prior to expiration of the timer, approving the first charge request; and
in response to expiration of the timer prior to receiving authorization of the first charge session from the owner, rejecting the first charge request.

14. The method of claim 1:
wherein receiving the first charge request from the first mobile device comprises receiving the first charge request from the first mobile device at a first time; and
wherein approving the first charge request comprises:
scheduling the first charge session during the first charge window succeeding the first time;
generating a notification indicating approval of the first charge request and specifying the first charge window for the first charge session; and
transmitting the notification to the first user at the first mobile device.

15. The method of claim 14:
wherein scheduling the first charge session during the first charge window comprises:
generating a charge session packet comprising the first station identifier, the first vehicle identifier, and the first set of charge parameters; and
storing the charge session packet in a scheduling database comprising a corpus of charge session packets corresponding to scheduled charge sessions; and
further comprising:
at a second time succeeding the first time, receiving the first vehicle identifier from the first charging station;
based on the first vehicle identifier and the first station identifier, retrieving the charge session packet;
extracting the first charge window defined by the charge session packet;
in response to the second time falling within a threshold duration of the first charge window, triggering the first charge station to enable charging of the first electric vehicle according to the first set of charge parameters and initiating the first charge session.

16. The method of claim 1:
wherein extracting the set of target charge parameters comprises extracting the set of target charge parameters comprising a set of target charge windows; and
further comprising, in response to receiving the first charge request, extracting a set of verification settings from the first owner profile, the set of verification settings comprising a first verification setting specifying:
automatic authorization of charge requests for charge sessions falling within the set of target charge windows;
owner verification of charge requests for charge sessions falling within a threshold duration of the set of target charge windows; and
automatic rejection of charge requests for charge sessions falling outside the threshold duration of the set of target charge windows;
wherein characterizing the first difference between the first set of charge parameters and the set of target charge parameters comprises characterizing the first difference between the first charge window and the set of target charge windows; and
wherein generating the first verification request in response to the first difference exceeding the difference comprises generating the first verification request in response to the first charge window falling within the threshold duration of a first target charge window in the set of target charge windows.

17. The method of claim 1, wherein approving the first charge request further comprises:
triggering the first charge station to enable charging of the first electric vehicle according to the first set of charge parameters;
accessing a transaction value defined for the first charge session;
accessing a user profile, in a set of user profiles, associated with the first user based on the first vehicle identifier;
extract a first wallet identifier, from the first user profile, corresponding to a first financial account associated with the first user;
extract a second wallet identifier, from the owner profile, corresponding to a second financial account associated with the owner; and
initiate payment from the first user to the owner, for the first charge session, according to the transaction value based on the first wallet identifier and the second wallet identifier.

18. A method comprising:
during a first time period, in response to receiving a first charge request for a first charge session:
extracting a first set of request characteristics defined by the first charge request and comprising:
a first station identifier associated with a first charging station;
a first vehicle identifier associated with a first electric vehicle affiliated with a first user; and
a first set of charge parameters comprising a first charge window; and
accessing a first owner profile, in a set of owner profiles, associated with an owner of the first charging station based on the first station identifier;
extracting a set of target charge parameters defined by the first owner from the first owner profile;
characterizing a first difference between the first set of charge parameters and the set of target charge parameters; and
in response to the first difference exceeding a threshold difference:
generating a first verification request comprising a first prompt to review the first charge request for the first charge session;
transmitting the first verification request to a first mobile device affiliated with the owner; and
in response to the owner withholding authorization of the first charge session, rejecting the first charge request; and
during a second time period, in response to receiving a second charge request for a second charge session:
extracting a second set of request characteristics defined by the second charge request and comprising:
the first station identifier;
a second vehicle identifier associated with a second electric vehicle affiliated with a second user; and
a second set of charge parameters comprising a second charge window; and
characterizing a second difference between the first set of charge parameters and the set of target charge parameters; and
in response to a second difference falling below the threshold difference, approving the second charge request.

19. The method of claim 18:
wherein rejecting the first charge request in response to the owner withholding authorization of the first charge session comprises:
in response to the transmitting the first verification request to the first mobile device affiliated with the owner, initiating a timer;
in response to receiving rejection of the first charge session prior to expiration of the timer, rejecting the first charge request; and
in response to expiration of the timer prior to receiving authorization of the first charge session, rejecting the first charge request; and
further comprising, in response to receiving authorization of the first charge session prior to expiration of the timer, approving the first charge request.

20. A method comprising:
during a first time period:
receiving a first charge request for a first charge session from a first mobile device accessed by a first user, the first charge request defining a first set of request characteristics comprising:
a first station identifier associated with a first charging station;
a first vehicle identifier associated with a first electric vehicle affiliated with the first user; and
a first set of charge parameters comprising a first charge amount; and
in response to receiving the first charge request:
accessing a first owner profile, in a set of owner profiles, associated with an owner of the first charging station based on the first station identifier;
extracting a set of target charge parameters defined by the first owner from the first owner profile, the set of target charge parameters comprising a threshold charge amount;
in response to the first charge amount falling below the threshold charge amount:
generating a first verification request comprising a first prompt to review the first charge request for the first charge session;
transmitting the first verification request to a second mobile device affiliated with the owner; and
in response to receiving authorization of the first charge session from the owner at the second mobile device, approving the first charge request; and
during a second time period:
receiving a second charge request for a second charge session from a third mobile device accessed by a second user, the second request defining a second set of request characteristics comprising:
the first station identifier associated with the first charging station;
a second vehicle identifier associated with a second electric vehicle affiliated with the second user; and
a second set of charge parameters comprising a second charge amount; and
in response to receiving the second charge request and in response to the second charge amount falling below the threshold amount, approving the second charge request.
